(19) United States
(12) Patent Application Publication
(10) Pub. No.: US 2018/0145298 A1
(43) Pub. Date: May 24, 2018

(54) BATTERY SEPARATORS AND RELATED METHODS

(71) Applicant: Hollingsworth & Vose Company, East Walpole, MA (US)

(72) Inventors: Yuri Vulfson, Corvallis, OR (US); Nicolas Clement, Littleton, MA (US); John J. Herrington, III, Corvallis, OR (US)

(73) Assignee: Hollingsworth & Vose Company, East Walpole, MA (US)

(21) Appl. No.: 15/359,902

(22) Filed: Nov. 23, 2016

(51) Int. Cl. H01M 2/16; H01M 2/18; H01M 10/08

(52) U.S. Cl. CPC H01M 2/1613; H01M 2300/0011; H01M 10/08; H01M 2/18

(57) ABSTRACT

Battery separators and related methods are generally provided. The battery separators may include one or more fiber webs. In some embodiments, one or more fiber webs of the battery separator comprises a plurality of glass fibers wherein at least a portion of the glass fibers are fused. The fiber web(s) may include, for example, glass fibers having particular glass compositions (e.g., a particular Li₂O content), and/or at least two different glass fibers having a minimum difference in softening temperatures. The one or more fiber webs may be designed to have desirable properties such as relatively high structural integrity (e.g., during acid filling of the battery such as in lead-acid batteries), enhanced separator stability, and/or enhanced wettability (e.g., wettability to acid) as compared to certain existing battery separators.

### FIELD

The present embodiments generally relate to fiber webs that can be used in or as battery separators for batteries, such as lead acid batteries.

### BACKGROUND

Batteries convert stored chemical energy into electrical energy and are commonly used as energy sources. Typically, a battery comprises one or more electrochemical cells including a negative electrode, a positive electrode, an electrolyte, and a battery separator. Battery separators are a critical component in many batteries. The battery separator mechanically and electrically isolates the negative and positive electrodes, while also allowing ions in the electrolyte to move between the electrodes.

Battery separators should be chemically, mechanically, and electrochemically stable under the strongly reactive environments in the battery during operation, should not adversely interact with the electrolyte and/or electrode materials, and have no deleterious effect on of the battery's performance (e.g., energy production, cycle life, safety). For example, the battery separator should not degrade, leach harmful components, react in a negative way with the electrode materials, allow short circuits to form between the electrodes, and/or crack or break during battery assembly and/or operation. Though many battery separators exist, improvements in the stability of battery separators and/or battery separators that lead to enhanced battery performance are needed.

### SUMMARY

The present embodiments generally relate to fiber webs that can be used in or as battery separators for batteries.

In one aspect, battery separators are provided. In some embodiments, the battery separator comprises a fiber web comprising a plurality of glass fibers, wherein at least a portion of the plurality of glass fibers are fused with one another, and wherein the fiber web has a basis weight of greater than or equal to 10 gsm and less than or equal to 700 gsm. The plurality of glass fibers comprises individual fibers having greater than or equal to 2 wt % and less than or equal to 7 wt % Li₂O versus the weight of the individual fibers.

In some embodiments, the battery separator comprises a fiber web comprising a first plurality of glass fibers and a second plurality of glass fibers, wherein the first and second pluralities of glass fibers are microglass fibers, wherein the fiber web has a basis weight of greater than or equal to 10 gsm and less than or equal to 700 gsm, wherein the first plurality of glass fibers has a first softening temperature, wherein the second plurality of glass fibers has a second softening temperature, and wherein the first softening temperature is greater than the second softening temperature by at least 40° C.

In some embodiments, the battery separator comprises a fiber web comprising a first plurality of glass fibers and a plurality of fused glass portions, wherein the first plurality of glass fibers are microglass fibers, and wherein the plurality of fused glass portions are formed from softened microglass fibers, wherein the fiber web has a basis weight of greater than or equal to 10 gsm and less than or equal to 700 gsm, wherein the first plurality of glass fibers has a first softening temperature, wherein the plurality of fused glass portions has a second softening temperature, and wherein the first softening temperature is greater than the second softening temperature by at least 40° C.

In some embodiments, the battery separator comprises a fiber web comprising a first plurality of glass fibers and a second plurality of glass fibers, wherein the first and second pluralities of glass fibers are microglass fibers, wherein the first plurality of glass fibers has a first softening temperature, wherein the second plurality of glass fibers has a second softening temperature, wherein the first softening temperature is greater than the second softening temperature by at least 40° C., and wherein the fiber web is formed by the process of heating the fiber web to a temperature of at least the second softening temperature but less than the first softening temperature.

In some embodiments, the battery separator comprises a fiber web comprising a first plurality of glass fibers and a second plurality of glass fibers, wherein the fiber web has a basis weight of greater than or equal to 10 gsm and less than or equal to 700 gsm, wherein the second plurality of glass fibers are present in the fiber web in an amount of at least 1 wt % versus the total fiber web weight, and wherein the second plurality of glass fibers have a softening temperature of less than or equal to 550° C.

In some embodiments, the battery separator comprises a fiber web comprising a first plurality of glass fibers and a second plurality of glass fibers, wherein the first plurality of glass fibers are microglass fibers having a first softening temperature, wherein the second plurality of glass fibers are chopped strand fibers having a second softening temperature, wherein the first softening temperature is greater than the second softening temperature by at least 40° C., and wherein the fiber web has a basis weight of greater than or equal to 10 gsm and less than or equal to 700 gsm.

In another aspect, methods for forming a battery separator are provided. In some embodiments, the method comprises heating a fiber web comprising a first plurality of glass fibers and a second plurality of glass fibers, wherein the first plurality of glass fibers and the second plurality of glass fibers are different in chemical composition. The method involves softening at least a portion of the second plurality of glass fibers.

In yet another aspect, glass fibers are provided. In some embodiments, the glass fiber comprises greater than or equal to 2 wt % and less than or equal to 7 wt % Li₂O, greater than or equal to 50 wt % and less than or equal to 80 wt % SiO₂, greater than or equal to 1 wt % and less than or equal to 6 wt % Al₂O₃, greater than or equal to 1 wt % and less than or equal to 10 wt % CaO, greater than or equal to 1 wt % and less than or equal to 8 wt % B₂O₃, greater than or equal to 0.1 wt % and less than or equal to 5 wt % K₂O, and greater than or equal to 0 wt % and less than or equal to 2 wt % F₂, wherein the glass fiber has a softening temperature of less than or equal to 550° C.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figure, which is schematic and is not intended to be drawn to scale. In the figure, each identical or nearly identical component illustrated is typically represented by a single numeral. For purposes of clarity, not every component is labeled, nor is every component of each embodiment of the invention shown where illustration is not necessary to allow those of ordinary skill in the art to understand the invention. In the figures:

FIG. 1A is a schematic diagram showing a cross-section of a fiber web according to one set of embodiments.

FIG. 1B is a schematic diagram of a plurality of fibers of a fiber web according to one set of embodiments.

FIG. 1C is a schematic diagram of a method of forming a fiber web comprising a plurality of fibers by softening at least a portion of the fibers according to one set of embodiments.

FIG. 1D is a schematic diagram of a method of forming a fiber web comprising a first plurality of fibers and a second plurality of fibers by softening at least a portion of the second plurality of fibers according to one set of embodiments.

FIG. 2A is a schematic diagram of a first plurality of fibers and a second plurality of fibers according to one set of embodiments.

FIG. 2B is a schematic diagram of a method of forming a fiber web comprising a first plurality of fibers and a second plurality of fibers by softening at least a portion of the fibers according to one set of embodiments.

FIG. 3 is a schematic diagram of an exemplary battery separator according to one set of embodiments.

FIG. 4A is a schematic diagram of a battery including a battery separator according to one set of embodiments.

FIG. 4B is a schematic diagram of a battery including a battery separator according to one set of embodiments.

FIG. 5A is an SEM image of an exemplary battery separator comprising fiber web having a plurality of fused fibers, according to one set of embodiments.

FIG. 5B is an SEM image of an exemplary comparative battery separator comprising a fiber web without fused fibers.

FIG. 6 is a box plot of the dry tensile strength of exemplary battery separators according to one set of embodiments.

FIG. 7 is a box plot of the wet tensile strength of exemplary battery separators according to one set of embodiments.

### DETAILED DESCRIPTION

Battery separators and related methods are generally provided. The battery separators may include one or more fiber webs. In some embodiments, one or more fiber webs of the battery separator comprises a plurality of glass fibers wherein at least a portion of the glass fibers are fused. The fiber web(s) may include, for example, glass fibers having particular glass compositions (e.g., a particular Li₂O content), and/or at least two different glass fibers having a minimum difference in softening temperatures. The one or more fiber webs may be designed to have desirable properties such as relatively high structural integrity (e.g., during acid filling of the battery such as in lead-acid batteries), enhanced separator stability, and/or enhanced wettability (e.g., wettability to acid) as compared to certain existing battery separators.

In an exemplary embodiment, the battery separator comprises a fiber web including at least a first plurality of glass fibers having a particular softening temperature. In some such embodiments, the fiber web may be formed by increasing the temperature of the glass fibers in the fiber web to a temperature above the softening temperature, such that at least a portion of the glass fibers fuse to one another. In some cases, the fiber web comprises a second plurality of glass fibers having a softening temperature greater than that of the first plurality of glass fibers (e.g., at least 40° C. greater). The fused glass fibers may increase the mechanical strength (e.g., the dry tensile strength) of the fiber web as compared to fiber webs without fused fibers, all other factors being equal. In another exemplary embodiment, the battery separator comprises a plurality of glass fibers having a particular Li₂O content (e.g., greater than or equal to 2 wt % and less than or equal to 7 wt % Li₂O). These and other configurations are described in more detail below.

The battery separators described herein may be well suited for a variety of battery types, including lead acid batteries.

In a typical battery, the battery separator primarily functions to electrically and mechanically isolate the negative electrode and positive electrode, while allowing ionic conduction. However, the presence of the battery separator between the electrodes can affect battery performance (e.g., electrical resistance, lifetime). For instance, the battery separator generally increases the resistance to ion movement between the electrodes compared to the electrolyte alone and thus increases the electrical resistance of the battery. Moreover, the battery separator can reduce the amount of electrolyte between the electrodes compared to the electrolyte alone for a given volume between the electrodes), due to the volume occupied by the battery separator. This reduction of electrolyte can limit the battery capacity.

In general, the chemical (e.g., composition, stability, wettability), structural (e.g., porosity, pore size, thickness, permeability), and/or mechanical (e.g., strength, stiffness) properties of the battery separator can affect battery performance (e.g., electrical resistance, lifetime). In some battery applications, a trade-off exists between the properties of the battery separator that provide sufficient isolation and/or ion movement, and battery performance. For instance, a battery separator having a sufficient porosity to allow for ion mobility may be damaged during acid filling and/or battery cycling, resulting in early battery failure. The balance of separator and battery performance is further aggravated in battery applications that utilize highly reactive operating conditions, such as lead acid batteries. In such applications, the chemical, mechanical, and electrochemical stability of the battery separator may be important design parameters to be balanced with separator and battery performance. Often, conventional battery separators are designed to have desirable stability, separation performance, or battery performance at the expense of one or more other properties such as stability, separation performance, and/or battery performance. For example, some conventional battery separators have attempted to minimize the influence of the battery separator on capacity and electrical resistance by reducing the mass of the battery separator to increase the volume porosity. However, the tradeoff between mass and mechanical stability can limit this approach. Accordingly, there is a need for improved battery separators.

In the present disclosure, battery separators are provided. In some embodiments, a battery separator may include a layer (e.g., a fiber web) comprising a plurality of glass fibers wherein at least a portion of the glass fibers are fused to one another. For instance, one or more glass fibers of the fiber web may be fused to one or more other glass fibers in the fiber web. Such a layer may be used alone, or in combination with an additional layer, in a battery separator as described in more detail below. As noted above, the fused glass fibers can be used to impart desirable properties to the battery separator and/or overall battery (e.g. stability, separation performance, battery performance). For instance, in some embodiments involving a battery comprising a layer (e.g., a fiber web) that includes fused glass fibers, the fused fibers may increase the mechanical strength (e.g., the dry tensile strength, the wet tensile strength) of the battery separator. In certain embodiments, these desirable properties can be imparted while having little or no adverse effects on another property of the battery separator and/or the overall battery.

In some embodiments, a battery separator comprising a layer (e.g., fiber web) described herein has reduced drawbacks compared to certain existing battery separators. For instance, in some embodiments involving a battery separator that includes glass fibers (e.g., fused glass fibers), the battery separator may permit rapid filling of the battery (e.g., with an acid such as in a lead-acid battery) without damaging the structure of the battery separator during electrolyte filling and/or battery cycling, since the battery separator may be strengthened and/or stabilized via fusion of at least a portion of the plurality of glass fibers within the separator. As described further below, such a battery separator may include, in some embodiments, a fiber web having at least a first plurality of glass fibers wherein at least a portion of the glass fibers are fused to one another. In certain embodiments, the fiber web does not include any binder resin, synthetic fibers, and/or inorganic particles. However, in other embodiments, such components may be included in the fiber web. For example, in some embodiments, the fiber web (and/or the battery separator including the fiber web) includes less than less than or equal to 5 wt %, less than or equal to 3 wt %, or less than or equal to 1 wt % synthetic fibers, binder resin, and/or inorganic particles versus the total weight of the fiber web. In certain embodiments, the fiber web (and/or the battery separator including the fiber web) includes greater than or equal to 0 wt %, greater than or equal to 1 wt %, or greater than or equal to 3 wt % synthetic fibers, binder resin, and/or inorganic particles versus the total weight of the fiber web. Combinations of the above-referenced ranges are also possible (e.g., greater than or equal to 0 wt % and less than or equal to 5 wt %). Other ranges are also possible.

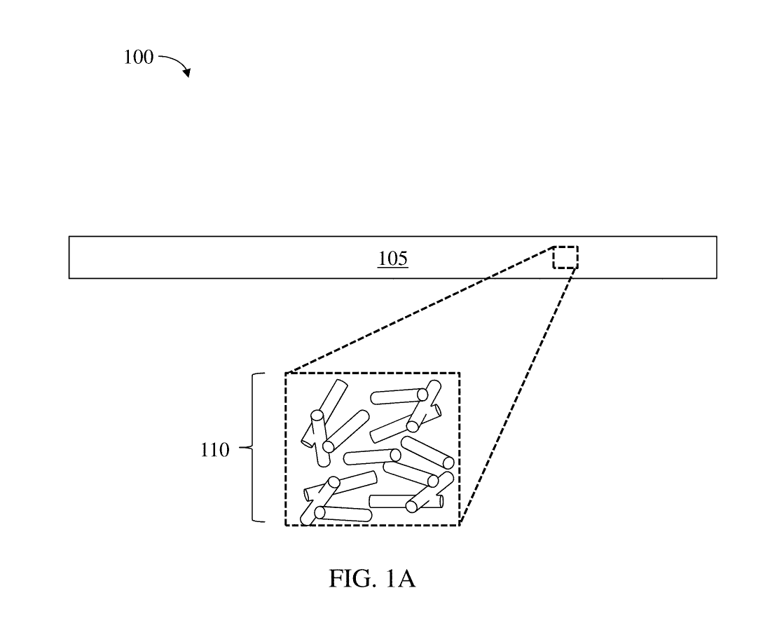

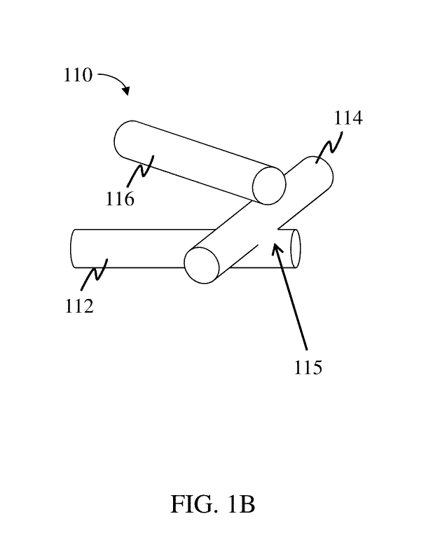

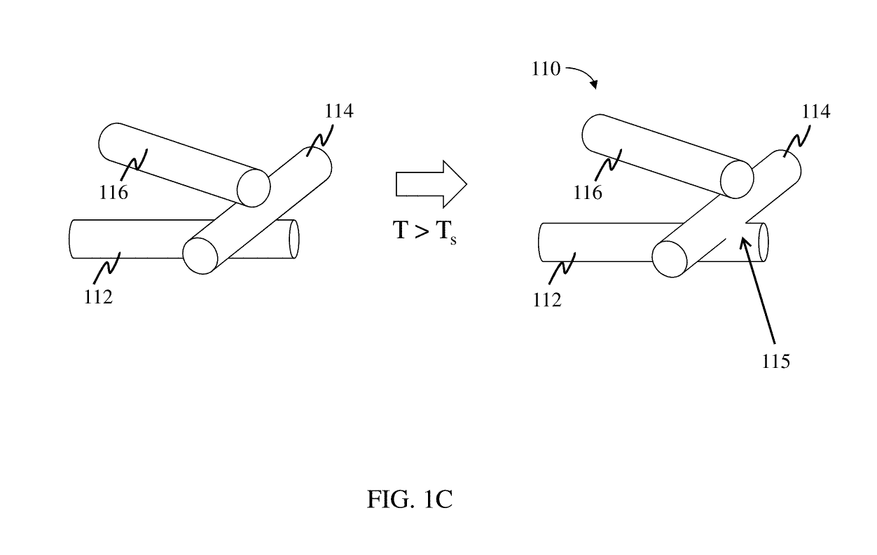

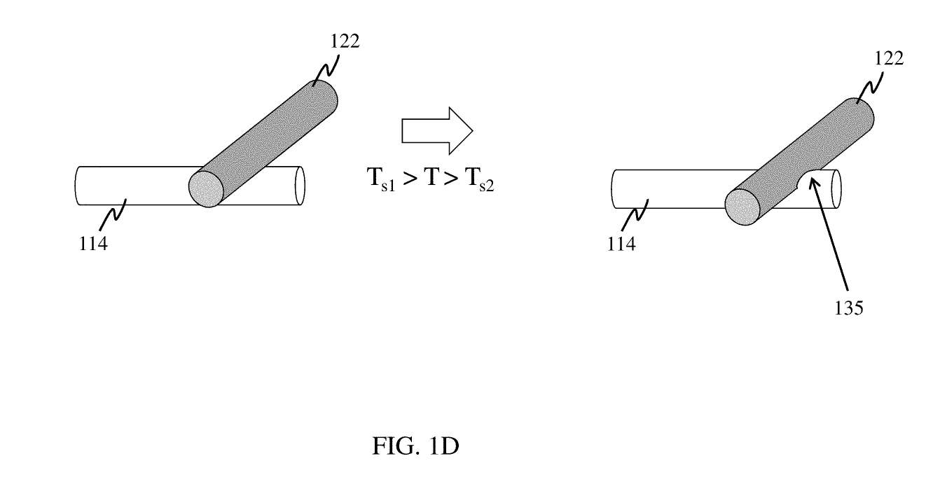

FIG. 1A is an illustrative embodiment of a battery separator including a fiber web as described herein. In some embodiments, a battery separator 100 comprises a fiber web 105 comprising a plurality of glass fibers 110. In some embodiments, at least a portion of glass fibers 110 comprises fused glass fibers. In an exemplary embodiment, as illustrated in FIG. 1B, glass fibers 110 comprises glass fiber 112, glass fiber 114, and glass fiber 116. In some embodiments, at least a portion of the plurality of glass fibers are fused. For example, as shown illustratively in FIG. 1B, glass fiber 112 and glass fiber 114 are fused at fused glass portion 115.

Those skilled in the art would understand based upon the teachings of this specification that two or more glass fibers are fused when those fibers are physically joined together through the softening of at least a portion of the surface of at least one of the two or more glass fibers at the location where the two or more glass fibers are in contact with one another, without any additional materials present between the glass fibers not already present in the glass fibers themselves (e.g., no binder resin or other adhesive that facilitates the fusion of the two glass fibers). Generally, the fusion of the glass fibers is irreversible. That is, the fused glass fibers can only be separated upon mechanical breakage of the glass fibers themselves, heating the fibers above the softening temperature, and/or chemical decomposition (e.g., via glass etching) of the glass fibers, each of which would not result in the recovery of the original two glass fibers as existed prior to fusion (e.g., each glass fiber would no longer have the same length, average diameter, surface roughness, and/or shape as prior to fusion of the two fibers).

It should be appreciated that not all fibers in a fiber web need to be softened in order to achieve the advantages of the battery separator described herein. For example, though glass fiber 112 may be fused to glass fiber 114 in some embodiments, in other embodiments, glass fiber 114 softened and glass fiber 112 did not soften.

For example, in certain embodiments, a first glass fiber having a first softening temperature may be in contact with a second glass fiber having a second softening temperature, where the first softening temperature is greater than the second softening temperature. The first glass fiber and the second glass fiber may become fused to one another by heating the fibers to a temperature greater than the second softening temperature and less than the first softening temperature, such that at least a portion of the second glass fibers soften. For example, as shown illustratively in FIG. 1D, glass fiber 122 having a first softening temperature, Tₛ₁, and glass fiber 114 having a second softening temperature, Tₛ₂ are in physical contact. In some embodiments, upon heating of the glass fibers to a temperature, T, greater than the second softening temperature and less than the first softening temperature, at least a portion of glass fiber 114 softens and fuses to glass fiber 122 at fused portion 135.

Non-limiting examples of heating methods (e.g., to soften and/or fuse fibers as described herein) include the use of an infrared heater, oven, furnace (e.g., a muffle), hot air oven steam-heated cylinder, or any other suitable types of sources of heat familiar to those of ordinary skill in the art. In some embodiments, the fibers or fiber web(s) can be flash heated, e.g., by infrared light (or other electromagnetic waves) or by a laser.

Generally, glass fibers of a particular type have a particular softening temperature. In certain embodiments, the plurality of glass fibers in a fiber web described herein have a relatively low softening temperature (e.g., less than or equal to 550° C.). In some such embodiments, the fibers that are in close proximity to one another or contacting one another may fuse together when heated to a temperature higher than the softening temperature of each of the fibers. For example, as shown illustratively in FIG. 1C, a fiber web may be formed by heating (e.g., baking, infrared heating, flash heating) a plurality of glass fibers (including glass fiber 112, glass fiber 114, and glass fiber 116) to a temperature, T, greater than the softening temperature, Tₛ, of the plurality of glass fibers, such that at least a portion of the plurality of glass fibers fuse to one another. In this particular example, at a temperature above the softening temperature of the plurality of glass fibers, glass fiber 112 and glass fiber 114 fuse to one another. Depending on the proximity between glass fiber 114 and glass 116, the fibers may or may not fuse to one another. The softening temperature of a plurality of glass fibers as described herein is measured by differential scanning calorimetry (DSC), and the softening temperature corresponds to the temperature at the peak on the DSC curve obtained at a rate of temperature increase of 20° C. per minute.

In some embodiments, the fiber web may be formed by heating the plurality of glass fibers to a temperature greater than the softening temperature of the plurality of glass fibers, such that glass fibers not in contact with another fiber maintain substantially the geometric characteristics (e.g., the same length, average diameter, surface roughness, and/or shape) as prior to heating the plurality glass fibers to the temperature greater than the softening temperature of the plurality of glass fibers. For instance, the plurality of glass fibers may be heated to a temperature such that at least a portion of the fibers fuse to one another without substantially altering the shape, length, average diameter, and/or surface roughness of the individual fibers (other than the portion of the surface of the fibers at which the fibers fuse to one another).

In some embodiments, the softening temperature of the plurality of glass fibers in a fiber web is greater than or equal to 450° C., greater than or equal to 460° C., greater than or equal to 480° C., greater than or equal to 500° C., greater than or equal to 510° C., greater than or equal to 520° C., or greater than or equal to 540° C. In certain embodiments, the softening temperature of the plurality of glass fibers is less than or equal to 550° C., less than or equal to 540° C., less than or equal to 520° C., less than or equal to 510° C., less than or equal to 500° C., less than or equal to 480° C., or less than or equal to 460° C. Combinations of the above-referenced ranges are also possible (e.g., greater than or equal to 450° C. and less than or equal to 550° C., greater than or equal to 480° C. and less than or equal to 520° C.). Other ranges are also possible. As described herein, at least a portion of the glass fibers having a softening temperature in one or more such ranges may include portions of the fibers that are fused to one another.

In certain embodiments, the fiber web may be formed by heating a plurality of glass fibers to a temperature that is at least 1° C., at least 2° C., at least 5° C., at least 10° C., at least 20° C., at least 40° C., at least 50° C., at least 75° C., at least 100° C., at least 125° C., at least 150° C., or at least 175° C. greater than the softening temperature of the plurality of glass fibers, such that at least a portion of the plurality of glass fibers fuse to one another. In some embodiments, the fiber web may be formed by heating the plurality of glass fibers to a temperature that is less than or equal to 200° C., less than or equal to 175° C., less than or equal to 150° C., less than or equal to 125° C., less than or equal to 100° C., less than or equal to 75° C., less than or equal to 50° C., less than or equal to 40° C., less than or equal to 20° C., less than or equal to 10° C., less than or equal to 5° C., or less than or equal to 2° C. greater than the softening temperature of the plurality of glass fibers, such that at least a portion of the plurality of glass fibers fuse to one another. Combinations of the above-referenced ranges are also possible (e.g., at least 1° C. and less than or equal to 200° C. greater than the softening temperature of the plurality of glass fibers, at least 10° C. and less than or equal to 50° C. greater than the softening temperature of the plurality of glass fibers). Other ranges are also possible.

In some embodiments, the fiber web may be formed by heating the plurality of glass fibers to a temperature greater than the softening temperature of the plurality of glass fibers (e.g., at least 10° C. and less than or equal to 50° C. greater than the softening temperature of the plurality of glass fibers) for at least 0.001 seconds, at least 0.005 seconds, at least 0.01 seconds, at least 0.05 seconds, at least 0.1 seconds, at least 0.5 seconds, at least 1 second, at least 2 seconds, at least 5 seconds, at least 10 seconds, at least 20 seconds, at least 30 seconds, at least 60 seconds, at least 120 seconds, at least 180 seconds, at least 240 seconds, at least 300 seconds, at least 360 seconds, at least 480 seconds, at least 600 seconds, at least 1200 seconds, at least 1800 seconds, at least 2400 seconds, or at least 3000 seconds, such that at least a portion of the plurality of glass fibers fuse to one another. In certain embodiments, the fiber web may be heated to a temperature greater than the softening temperature of the plurality of glass fibers for less than or equal to 3600 seconds, less than or equal to 3000 seconds, less than or equal to 2400 seconds, less than or equal to 1800 seconds, less than or equal to 1200 seconds, less than or equal to 600 seconds, less than or equal to 480 seconds, less than or equal to 360 seconds, less than or equal to 300 seconds, less than or equal to 180 seconds, less than or equal to 240 seconds, less than or equal to 120 seconds, less than or equal to 60 seconds, less than or equal to 30 seconds, less than or equal to 20 seconds, less than or equal to 10 seconds, less than or equal to 5 seconds, less than or equal to 2 seconds, less than or equal to 1 second, less than or equal to 0.5 seconds, less than or equal to 0.1 seconds, less than or equal to 0.05 seconds, less than or equal to 0.01 seconds, or less than or equal to 0.005 seconds. Combinations of the above-referenced ranges are also possible (e.g., at least 0.001 seconds and less than or equal to 3600 seconds, at least 0.1 seconds and less than or equal to 300 seconds). Other ranges are also possible.

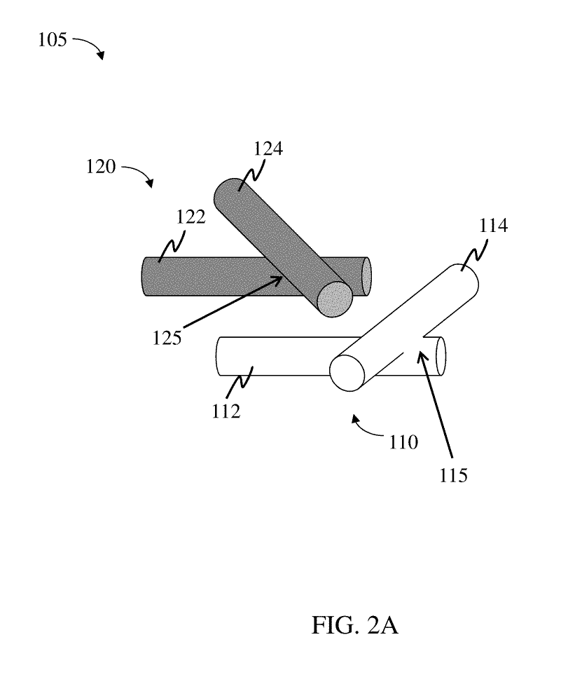

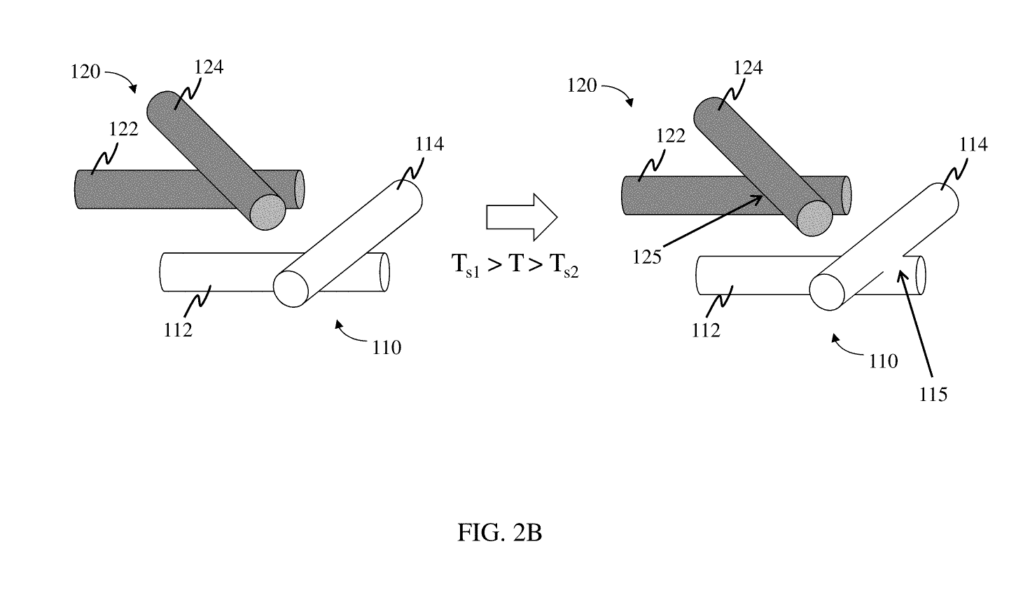

In certain embodiments, the battery separator may include a fiber web comprising a first plurality of glass fibers and a second plurality of glass fibers. In some such embodiments, the first plurality of glass fibers may have a first softening temperature (e.g., a relatively high softening temperature) and the second plurality of glass fibers may have a second softening temperature (e.g., a relatively low softening temperature), different than the first softening temperature. In an illustrative embodiment, as shown schematically in FIG. 2A, a fiber web 105 may comprise a first plurality of glass fibers 120 and a second plurality of glass fibers 110. In some embodiments, at least a portion of the second plurality of glass fibers are fused to one another and the first plurality of glass fibers are not fused to one another. For example, in some embodiments, first plurality of glass fibers 120 includes fiber 122 and fiber 124, where fiber 122 and fiber 124 are not fused (e.g., the fibers are not fused at portion 125 where the fibers contact one another). In some such embodiments, second plurality of glass fibers 110 includes fiber 112 and fiber 114, wherein fiber 112 and fiber 114 are fused to one another (e.g., at fused glass portion 115).

In some cases, at least a portion of the second plurality of glass fibers may fuse to at least a portion of the first plurality of glass fibers. For example, referring again to FIG. 1D, in some embodiments, glass fiber 122 (e.g., present within a first plurality of glass fibers) having a first softening temperature is fused to glass fiber 114 (e.g., present within a second plurality of glass fibers) where the fibers contact one another (e.g., fused portion 135). In some such embodiments, glass fiber 114 and glass fiber 122 are fused to one another by heating the glass fibers to a temperature greater than or equal to the softening temperature of glass fiber 114 and less than the softening temperature of glass fiber 122. In some such embodiments, glass fiber 114 may soften while glass fiber 122 does not soften.

In some embodiments, the fiber web comprising a first plurality of glass fibers and a second plurality of glass fibers may be formed at least in part by heating the first plurality of glass fibers and the second plurality of glass fibers to a temperature, T, greater than the softening temperature of the second plurality of glass fibers, Tₛ₂, and less than the softening temperature of the first plurality of glass fibers, Tₛ₁. In some such embodiments, at least a portion of the second plurality of glass fibers may fuse to one another after heating to a temperature greater than or equal to the softening temperature of the second plurality of glass fibers (and less than the softening temperature of the first plurality of glass fibers). In some embodiments, no glass fibers within the first plurality of glass fibers fuse to one another after heating to a temperature greater than the softening temperature of the second plurality of glass fibers (and less than the softening temperature of the first plurality of glass fibers).

For example, as illustrated in FIG. 2B, a fiber web may be formed by heating a first plurality of glass fibers 120 including fiber 122 and fiber 124, and second plurality of glass fibers 110 included fiber 112 and fiber 114, to a temperature, T, greater than the softening temperature of the second plurality of glass fibers, Tₛ₂, and less than the softening temperature of the first plurality of glass fibers, Tₛ₁ In some such embodiments, fiber 122 and fiber 124 do not fuse to one another (e.g., the fibers are not fused at portion 125 where the fibers contact one another). In some such embodiments, fiber 112 and fiber 114 fuse to one another (e.g., at fused glass portion 115).

In certain embodiments, the softening temperature of the first plurality of glass fibers (e.g., fibers having a relatively high softening temperature) is greater than the softening temperature of the second plurality of glass fibers (e.g., fibers having a relatively low softening temperature). In some such embodiments, the softening temperature of the first plurality of glass fibers may be higher than the softening temperature of the second plurality of glass fibers by greater than or equal to 40° C., greater than or equal to 60° C., greater than or equal to 80° C., greater than or equal to 100° C., greater than or equal to 120° C., greater than or equal to 150° C., greater than or equal to 200° C., greater than or equal to 250° C., greater than or equal to 300° C., greater than or equal to 400° C., or greater than or equal to 500° C. In certain embodiments, the softening temperature of the first plurality of glass fibers may be higher than the softening temperature of the second plurality of glass fibers by less than or equal to 600° C., less than or equal to 500° C., less than or equal to 400° C., less than or equal to 300° C., less than or equal to 250° C., less than or equal to 200° C., less than or equal to 150° C., less than or equal to 120° C., less than or equal to 100° C., less than or equal to 80° C., or less than or equal to 60° C. Combinations of the above-referenced ranges are also possible (e.g., greater than or equal to 40° C. and less than or equal to 600° C., greater than or equal to 40° C. and less than or equal to 100° C., greater than or equal to 60° C. and less than or equal to 80° C.). Other ranges are also possible.

In certain embodiments, the softening temperature of the second plurality of glass fibers (e.g., plurality of glass fibers having a relatively low softening temperature) is less than or equal to 550° C., less than or equal to 540° C., less than or equal to 520° C., less than or equal to 510° C., less than or equal to 500° C., less than or equal to 480° C., or less than or equal to 460° C. In some embodiments, the softening temperature of the second plurality of glass fibers is greater than or equal to 450° C., greater than or equal to 460° C., greater than or equal to 480° C., greater than or equal to 500° C., greater than or equal to 510° C., greater than or equal to 520° C., or greater than or equal to 540° C. Combinations of the above-referenced ranges are also possible (e.g., greater than or equal to 450° C. and less than or equal to 550° C., greater than or equal to 480° C. and less than or equal to 520° C.). Other ranges are also possible.

In certain embodiments, the softening temperature of the first plurality of glass fibers (e.g., first plurality of glass fibers having a relatively high softening temperature) is greater than 550° C., greater than or equal to 560° C., greater than or equal to 570° C., greater than or equal to 580° C., greater than or equal to 600° C., greater than or equal to 700° C., greater than or equal to 740° C., greater than or equal to 800° C., greater than or equal to 1000° C., or greater than or equal to 1200° C. In certain embodiments, the softening temperature of the first plurality of glass fibers is less than or equal to 1500° C., less than or equal to 1200° C., less than or equal to 1000° C., less than or equal to 800° C., less than or equal to 740° C., less than or equal to 700° C., less than or equal to 600° C., less than or equal to 580° C., or less than or equal to 570° C. Combinations of the above-referenced ranges are also possible (e.g., greater than 550° C. and less than or equal to 1200° C., greater than or equal to 560° C. and less than or equal to 1200° C., greater than or equal to 560° C. and less than or equal to 700° C., greater than or equal to 570° C. and less than or equal to 610° C.). Other ranges are also possible.

As described herein, in some embodiments a fiber web includes fused glass portions. In certain embodiments, the softening temperature of the first plurality of glass fibers (e.g., fibers having a relatively high softening temperature) is greater than the softening temperature of the fused glass portions (e.g., glass portions having a relatively low softening temperature). In some such embodiments, the softening temperature of the first plurality of glass fibers may be higher than the softening temperature of the fused glass portions by greater than or equal to 40° C., greater than or equal to 60° C., greater than or equal to 80° C., greater than or equal to 100° C., greater than or equal to 120° C., greater than or equal to 150° C., greater than or equal to 200° C., greater than or equal to 250° C., greater than or equal to 300° C., greater than or equal to 400° C., or greater than or equal to 500° C. In certain embodiments, the softening temperature of the first plurality of glass fibers may be higher than the softening temperature of the fused glass portions by less than or equal to 600° C., less than or equal to 500° C., less than or equal to 400° C., less than or equal to 300° C., less than or equal to 250° C., less than or equal to 200° C., less than or equal to 150° C., less than or equal to 120° C., less than or equal to 100° C., less than or equal to 80° C., or less than or equal to 60° C. Combinations of the above-referenced ranges are also possible (e.g., greater than or equal to 40° C. and less than or equal to 600° C., greater than or equal to 40° C. and less than or equal to 100° C., greater than or equal to 60° C. and less than or equal to 80° C.). Other ranges are also possible. In some embodiments, the softening temperature of the fused glass portions (e.g., glass portions having a relatively low softening temperature, such as the second softening temperature) is less than or equal to 550° C., less than or equal to 540° C., less than or equal to 520° C., less than or equal to 510° C., less than or equal to 500° C., less than or equal to 480° C., or less than or equal to 460° C. In certain embodiments, the softening temperature of the fused glass portions is greater than or equal to 450° C., greater than or equal to 460° C., greater than or equal to 480° C., greater than or equal to 500° C., greater than or equal to 510° C., greater than or equal to 520° C., or greater than or equal to 540° C. In certain embodiments, the softening temperature of the fused glass portions. Combinations of the above-referenced ranges are also possible (e.g., greater than or equal to 450° C. and less than or equal to 550° C., greater than or equal to 480° C. and less than or equal to 520° C.). Other ranges are also possible.

A battery separator and/or fiber web described herein may include both a first plurality fibers having a softening temperature Tₛ₁ in one or more of the above-referenced ranges, and a second plurality of fibers (and/or fused glass portions) having a softening temperature Tₛ₂ in one or more of the above-referenced ranges. In certain embodiments, the difference between Tₛ₁ and Tₛ₂ is greater than or equal to 40° C. and/or within one or more of the ranges described above.

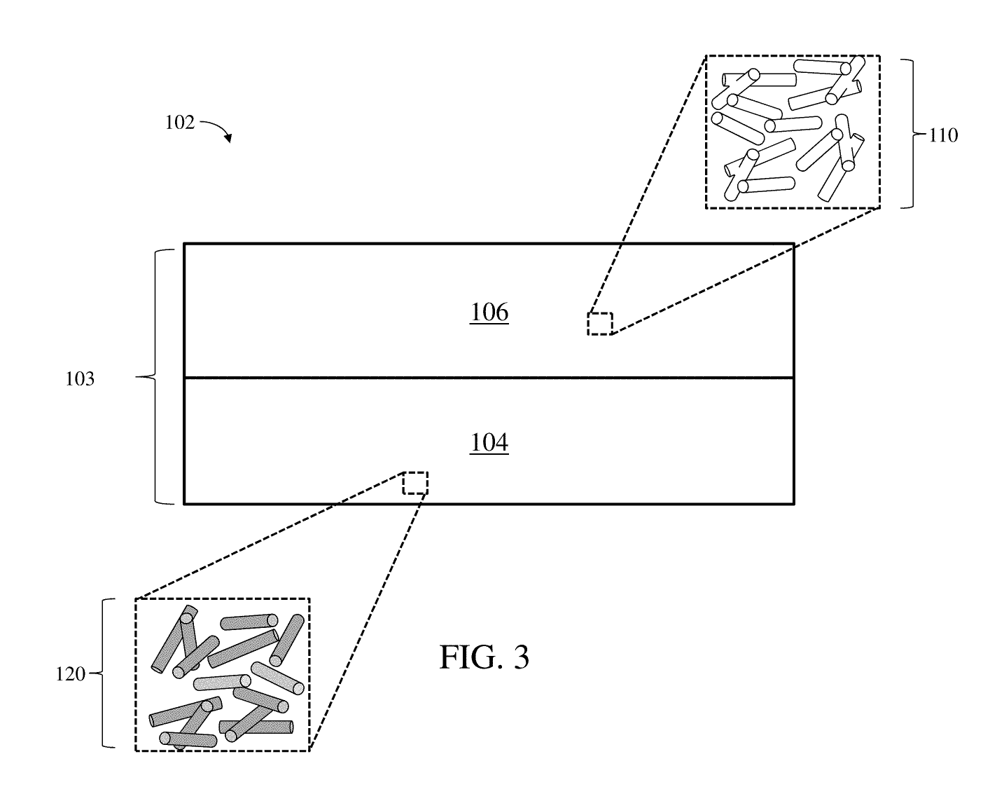

In embodiments in which both first and second pluralities of fibers are present in a battery separator or fiber web, the first and second pluralities of fibers may be present in any suitable configuration. In some embodiments, the first plurality of glass fibers and the second plurality of glass fibers are mixed (e.g., randomly) within the fiber web. In alternative embodiments, the fiber web may comprise a layer comprising the first plurality of glass fibers and a second layer comprising the second plurality of glass fibers adjacent (e.g., directly adjacent) the first layer. In some embodiments, at least a portion of the glass fibers in the first layer and/or second layer are fused to one another. For example, as illustrated in FIG. 3, a battery separator 102 includes a fiber web 103 including a first layer 104 adjacent (e.g., directly adjacent) a second layer 106. In some such embodiments, second layer 106 comprises a second plurality of glass fibers 110 and first layer 104 comprises a first plurality of glass fibers 120. In some embodiments, at least a portion of the second plurality of glass fibers of the second layer are fused to one another and/or have a relatively low softening temperature as described herein. In certain embodiments, substantially none of the first plurality of glass fibers of the first layer are fused to one another and/or have a relatively high softening temperature.

As used herein, when a layer or fiber web is referred to as being “adjacent” another layer or fiber web, it can be directly adjacent to the layer or fiber web, or an intervening layer or fiber web also may be present. A layer or fiber web that is “directly adjacent” another layer or fiber web means that no intervening layer or fiber web is present.

In embodiments in which the first and second pluralities of fibers are present in different layers of a fiber web, in some cases, the weight percentage of the first layer comprising a first plurality of glass fibers (e.g., fibers having a relatively high softening temperature) is greater than or equal to 50 wt %, greater than or equal to 60 wt %, greater than or equal to 70 wt %, greater than or equal to 80 wt %, greater than or equal to 90 wt %, greater than or equal to 95 wt %, or greater than or equal to 98 wt %, versus the total battery separator weight. In certain embodiments, the weight percentage of the first layer comprising a first plurality of glass fibers (e.g., fibers having a relatively high softening temperature) is less than or equal to 99 wt %, less than or equal to 98 wt %, less than or equal to 95 wt %, less than or equal to 90 wt %, less than or equal to 80 wt %, less than or equal to 70 wt %, or less than or equal to 60 wt %, versus the total battery separator weight. Combinations of the above-referenced ranges are also possible (e.g., greater than or equal to 50 wt % and less than or equal to 99 wt %, greater than or equal to 90 wt % and less than or equal to 95 wt %). Other ranges are also possible.

In some embodiments, the weight percentage of the second layer of a fiber web comprising a second plurality of glass fibers (e.g., fibers having a relatively low softening temperature) is greater than or equal to 1 wt %, greater than or equal to 5 wt %, greater than or equal to 10 wt %, greater than or equal to 20 wt %, greater than or equal to 30 wt %, greater than or equal to 40 wt %, or greater than or equal to 45 wt %, versus the total battery separator weight. In certain embodiments, the weight percentage of the second layer comprising a second plurality of glass fibers (e.g., fibers having a relatively low softening temperature) is less than or equal to 50 wt %, less than or equal to 45 wt %, less than or equal to 40 wt %, less than or equal to 30 wt %, less than or equal to 20 wt %, less than or equal to 10 wt %, or less than or equal to 5 wt %, versus the total battery separator weight. Combinations of the above-referenced ranges are also possible (e.g., greater than or equal to 1 wt % and less than or equal to 50 wt %, greater than or equal to 5 wt % and less than or equal to 10 wt %). Other ranges are also possible.

In some embodiments, one or more layers in the battery separator may be designed to be discrete from another layer of the fiber web. That is, the components (e.g., fibers) from one layer do not substantially intermingle (e.g., do not intermingle at all) with components (e.g., fibers) from another layer. For example, with respect to FIG. 3, in one set of embodiments, fibers from layer 106 do not substantially intermingle with fibers of layer 104. Discrete fiber webs may be joined by any suitable process including, for example, lamination, thermo-dot bonding, calendaring, ultrasonic processes, or by adhesives. It should be appreciated, however, that certain embodiments may include one or more layers that are not discrete with respect to one another (e.g., the components from one layer may intermingle with some components from another layer). For instance, a first layer may bond to a second layer due to the lower softening temperature of a component of the first layer. In some embodiments, two or more layers may be formed together via a wet laid process, a non-wet laid process, or any other suitable process.

While much of the description herein relates to fiber webs having one or two pluralities of glass fibers, those of ordinary skill in the art would understand based upon the teachings of this specification that the fiber web may also have combinations of three or more, four or more, or five or more pluralities of glass fibers. Similarly, while much of the description herein relates to fiber webs having one or two layers, each layer comprising at least one plurality of glass fibers (e.g., a first plurality of glass fibers and/or a second plurality of glass fibers), those of ordinary skill in the art would understand based upon the teachings of this specification that the fiber web may include three or more, four or more, or five or more layers (e.g., each layer comprising a plurality of glass fibers, such as a third plurality of glass fibers, a fourth plurality of glass fibers, etc.).

It should be appreciated that in embodiments in which first and second pluralities of fibers are present in a battery separator or fiber web described herein, in some embodiments, the first plurality of glass fibers and second plurality of glass fibers may be different in chemical composition (e.g., glass formulation), fiber size (e.g., fiber diameter), softening temperature, and/or other characteristics. Similarly, the second plurality of glass fibers may be different from a third plurality of glass fibers and/or a fourth plurality of glass fibers. In other embodiments, two pluralities of glass fibers (e.g., between different layers) may be the same. For example, in some embodiments, a first plurality of glass fibers present in a first layer may be the same as a third plurality of glass fibers present in a second layer. Other configurations are also possible.

In some embodiments, the plurality of glass fibers (e.g., second plurality of fibers) having a relatively low softening temperature (e.g., less than or equal to 550° C.) may have a particular chemical composition. For example, in some embodiments, the glass fibers (and/or fused glass portions) may comprise Li₂O, SiO₂, Al₂O₃, CaO, B₂O₃, K₂O, F₂, Na₂O, MgO, BaO, and/or combinations thereof.

In some embodiments, Li₂O is present in the plurality of glass fibers (and/or fused glass portions) in an amount greater than or equal to 0.2 wt %, greater than or equal to 0.5 wt %, greater than or equal to 1 wt %, greater than or equal to 1.5 wt %, greater than or equal to 2 wt %, greater than or equal to 2.5 wt %, greater than or equal to 3 wt %, greater than or equal to 3.5 wt %, greater than or equal to 4 wt %, greater than or equal to 4.5 wt %, greater than or equal to 5 wt %, greater than or equal to 5.5 wt %, or greater than or equal to 6 wt % versus the total weight of the plurality of glass fibers in the fiber web or separator. In certain embodiments, Li₂O is present in the plurality of glass fibers (and/or fused glass portions) in an amount less than or equal to 7 wt %, less than or equal to 6.5 wt %, less than or equal to 6 wt %, less than or equal to 5.5 wt %, less than or equal to 5 wt %, less than or equal to 4.5 wt %, less than or equal to 4 wt %, less than or equal to 3.5 wt %, less than or equal to 3 wt %, less than or equal to 2.5 wt %, less than or equal to 2 wt %, less than or equal to 1 wt %, or less than or equal to 0.5 wt % versus the total weight of the plurality of the glass fibers in the fiber web or separator. Combinations of the above referenced ranges are also possible (e.g., greater than or equal to 0.2 wt % and less than or equal to 7 wt %, greater than or equal to 1 wt % and less than or equal to 7 wt %, greater than or equal to 2 wt % and less than or equal to 4 wt %). Other ranges are also possible. In some embodiments, the plurality of glass fibers noted above may be the second plurality of glass fibers where more than one plurality of glass fibers (e.g., first plurality of fibers, second plurality of fibers) are present in a fiber web and/or separator. For instance, each recitation of “glass fibers” above may be replaced with “second plurality of glass fibers”. In some embodiments individual glass fibers in the plurality of glass fibers have Li₂O present in the ranges described above with respect to the weight of the individual glass fibers. For example, the plurality of glass fibers may comprise individual fibers having greater than or equal to 2 wt % and less than or equal to 7 wt % Li₂O versus the weight of the individual fibers. In other embodiments, the plurality of glass fibers may comprise individual fibers having other combinations of ranges of Li₂O described above versus the weight of the individual fibers.

In certain embodiments, the fiber web comprising a plurality of glass fibers (e.g., second plurality of fibers) and/or fused glass portions comprises greater than or equal to 0.2 wt % Li₂O versus the total weight of the fiber web or separator. For example, in some embodiments, Li₂O is present in the fiber web or separator in an amount greater than or equal to 0.2 wt %, greater than or equal to 0.5 wt %, greater than or equal to 1 wt %, greater than or equal to 1.5 wt %, greater than or equal to 2 wt %, greater than or equal to 2.5 wt %, greater than or equal to 3 wt %, greater than or equal to 3.5 wt %, greater than or equal to 4 wt %, greater than or equal to 4.5 wt %, greater than or equal to 5 wt %, greater than or equal to 5.5 wt %, or greater than or equal to 6 wt % versus the total weight of the fiber web or separator. In certain embodiments, Li₂O is present in the fiber web (and/or fused glass portions) in an amount less than or equal to 7 wt %, less than or equal to 6.5 wt %, less than or equal to 6 wt %, less than or equal to 5.5 wt %, less than or equal to 5 wt %, less than or equal to 4.5 wt %, less than or equal to 4 wt %, less than or equal to 3.5 wt %, less than or equal to 3 wt %, less than or equal to 2.5 wt %, less than or equal to 2 wt %, less than or equal to 1 wt %, or less than or equal to 0.5 wt % versus the total weight of the fiber web. Combinations of the above referenced ranges are also possible (e.g., greater than or equal to 0.2 wt % and less than or equal to 7 wt %, greater than or equal to 1 wt % and less than or equal to 7 wt %). Other ranges are also possible.

In some embodiments, SiO₂ is present in the plurality of glass fibers (and/or fused glass portions) in an amount greater than or equal to 30 wt %, greater than or equal to 40 wt %, greater than or equal to 50 wt %, greater than or equal to 55 wt %, greater than or equal to 60 wt %, greater than or equal to 61 wt %, greater than or equal to 63 wt %, greater than or equal to 65 wt %, greater than or equal to 70 wt %, or greater than or equal to 75 wt % versus the total weight of the plurality of glass fibers in the fiber web or separator. In certain embodiments, SiO₂ is present in the plurality of glass fibers (and/or fused glass portions) in an amount less than or equal to 80 wt %, less than or equal to 70 wt %, less than or equal to 65 wt %, less than or equal to 63 wt %, less than or equal to 61 wt %, less than or equal to 60 wt %, less than or equal to 55 wt %, less than or equal to 50 wt %, or less than or equal to 40 wt % versus the total weight of the plurality of glass fibers in the fiber web or separator. Combinations of the above referenced ranges are also possible (e.g., greater than or equal to 30 wt % and less than or equal to 80 wt %, greater than or equal to 61 wt % and less than or equal to 70 wt %). Other ranges are also possible. In some embodiments, the plurality of glass fibers noted above may be the second plurality of glass fibers where more than one plurality of glass fibers (e.g., first plurality of fibers, second plurality of fibers) are present in a fiber web and/or separator. For instance, each recitation of “glass fibers” above may be replaced with “second plurality of glass fibers”. In some embodiments, individual glass fibers in the plurality of glass fibers have SiO₂ present in the ranges described above with respect to the weight of the individual glass fibers. For example, the plurality of glass fibers may comprise individual fibers having greater than or equal to 30 wt % and less than or equal to 80 wt % SiO₂ versus the weight of the individual fibers. In other embodiments, the plurality of glass fibers may comprise individual fibers having other combinations of ranges of SiO₂ described above versus the weight of the individual fibers.

In some embodiments, the fiber web comprising a plurality of glass fibers (e.g., second plurality of fibers) and/or fused glass portions comprises SiO₂ in an amount greater than or equal to 30 wt %, greater than or equal to 40 wt %, greater than or equal to 50 wt %, greater than or equal to 55 wt %, greater than or equal to 60 wt %, greater than or equal to 61 wt %, greater than or equal to 63 wt %, greater than or equal to 65 wt %, greater than or equal to 70 wt %, or greater than or equal to 75 wt % versus the total weight of the fiber web or separator. In certain embodiments, SiO₂ is present in the fiber web (and/or fused glass portions) in an amount less than or equal to 80 wt %, less than or equal to 70 wt %, less than or equal to 65 wt %, less than or equal to 63 wt %, less than or equal to 61 wt %, less than or equal to 60 wt %, less than or equal to 55 wt %, less than or equal to 50 wt %, or less than or equal to 40 wt % versus the total weight of the fiber web or separator. Combinations of the above referenced ranges are also possible (e.g., greater than or equal to 30 wt % and less than or equal to 80 wt %, greater than or equal to 61 wt % and less than or equal to 70 wt %). Other ranges are also possible.

In certain embodiments, Al₂O₃ is present in the plurality of glass fibers (and/or fused glass portions) in an amount greater than or equal to 0.2 wt %, greater than or equal to 0.5 wt %, greater than or equal to 1 wt %, greater than or equal to 2 wt %, greater than or equal to 3 wt %, greater than or equal to 4 wt %, or greater than or equal to 5 wt % versus the total weight of the plurality of glass fibers in the fiber web or separator. In certain embodiments, Al₂O₃ is present in the plurality of glass fibers (and/or fused glass portions) in an amount less than or equal to 6 wt %, less than or equal to 5 wt %, less than or equal to 4 wt %, less than or equal to 3 wt %, less than or equal to 2 wt %, less than or equal to 1 wt %, or less than or equal to 0.5 wt % versus the total weight of the plurality of glass fibers in the fiber web or separator. Combinations of the above referenced ranges are also possible (e.g., greater than or equal to 0.2 wt % and less than or equal to 6 wt %, greater than or equal to 2 wt % and less than or equal to 4 wt %). Other ranges are also possible. In some embodiments, the plurality of glass fibers noted above may be the second plurality of glass fibers where more than one plurality of glass fibers (e.g., first plurality of fibers, second plurality of fibers) are present in a fiber web and/or separator. For instance, each recitation of “glass fibers” above may be replaced with “second plurality of glass fibers”. In some embodiments, individual glass fibers in the plurality of glass fibers have Al₂O₃ present in the ranges described above with respect to the weight of the individual glass fibers. For example, the plurality of glass fibers may comprise individual fibers having greater than or equal to 0.2 wt % and less than or equal to 6 wt % Al₂O₃ versus the weight of the individual fibers. In other embodiments, the plurality of glass fibers may comprise individual fibers having other combinations of ranges of Al₂O₃ described above versus the weight of the individual fibers.

In certain embodiments, the fiber web comprising a plurality of glass fibers (e.g., second plurality of fibers) and/or fused glass portions comprises Al₂O₃ in an amount greater than or equal to 0.2 wt %, greater than or equal to 0.5 wt %, greater than or equal to 1 wt %, greater than or equal to 2 wt %, greater than or equal to 3 wt %, greater than or equal to 4 wt %, or greater than or equal to 5 wt % versus the total weight of the fiber web or separator. In certain embodiments, Al₂O₃ is present in the plurality of glass fibers (and/or fused glass portions) in an amount less than or equal to 6 wt %, less than or equal to 5 wt %, less than or equal to 4 wt %, less than or equal to 3 wt %, less than or equal to 2 wt %, less than or equal to 1 wt %, or less than or equal to 0.5 wt % versus the total weight of the fiber web or separator. Combinations of the above referenced ranges are also possible (e.g., greater than or equal to 0.2 wt % and less than or equal to 6 wt %, greater than or equal to 2 wt % and less than or equal to 4 wt %). Other ranges are also possible.

In certain embodiments, MgO is present in the plurality of glass fibers (and/or fused glass portions) in an amount greater than or equal to 0.2 wt %, greater than or equal to 0.5 wt %, greater than or equal tol wt %, greater than or equal to 2 wt %, greater than or equal to 3 wt %, greater than or equal to 4 wt %, or greater than or equal to 5 wt % versus the total weight of the plurality of glass fibers in the fiber web or separator. In certain embodiments, MgO is present in the plurality of glass fibers (and/or fused glass portions) in an amount less than or equal to 6 wt %, less than or equal to 5 wt %, less than or equal to 4 wt %, less than or equal to 3 wt %, less than or equal to 2 wt %, less than or equal to 1 wt %, or less than or equal to 0.5 wt % versus the total weight of the plurality of glass fibers in the fiber web or separator. Combinations of the above referenced ranges are also possible (e.g., greater than or equal to 0.2 wt % and less than or equal to 6 wt %, greater than or equal to 2 wt % and less than or equal to 4 wt %). Other ranges are also possible. In some embodiments, the plurality of glass fibers noted above may be the second plurality of glass fibers where more than one plurality of glass fibers (e.g., first plurality of fibers, second plurality of fibers) are present in a fiber web and/or separator. For instance, each recitation of “glass fibers” above may be replaced with “second plurality of glass fibers”. In some embodiments, individual glass fibers in the plurality of glass fibers have MgO present in the ranges described above with respect to the weight of the individual glass fibers. For example, the plurality of glass fibers may comprise individual fibers having greater than or equal to 0.2 wt % and less than or equal to 6 wt % MgO versus the weight of the individual fibers. In other embodiments, the plurality of glass fibers may comprise individual fibers having other combinations of ranges of MgO described above versus the weight of the individual fibers.

In certain embodiments, the fiber web comprising a plurality of glass fibers (e.g., second plurality of fibers) and/or fused glass portions comprises MgO in an amount greater than or equal to 0.2 wt %, greater than or equal to 0.5 wt %, greater than or equal to 1 wt %, greater than or equal to 2 wt %, greater than or equal to 3 wt %, greater than or equal to 4 wt %, or greater than or equal to 5 wt % versus the total weight of the fiber web or separator. In certain embodiments, MgO is present in the plurality of glass fibers (and/or fused glass portions) in an amount less than or equal to 6 wt %, less than or equal to 5 wt %, less than or equal to 4 wt %, less than or equal to 3 wt %, less than or equal to 2 wt %, less than or equal to 1 wt %, or less than or equal to 0.5 wt % versus the total weight of the fiber web or separator. Combinations of the above referenced ranges are also possible (e.g., greater than or equal to 0.2 wt % and less than or equal to 6 wt %, greater than or equal to 2 wt % and less than or equal to 4 wt %). Other ranges are also possible.

In some embodiments, CaO is present in the plurality of glass fibers (and/or fused glass portions) in an amount greater than or equal to 0.2 wt %, greater than or equal to 0.5 wt %, greater than or equal to 1 wt %, greater than or equal to 3 wt %, greater than or equal to 5 wt %, greater than or equal to 7 wt %, or greater than or equal to 9 wt % versus the total weight of the plurality of glass fibers in the fiber web or separator. In certain embodiments, CaO is present in the plurality of glass fibers (and/or fused glass portions) in an amount less than or equal to 10 wt %, less than or equal to 9 wt %, less than or equal to 7 wt %, less than or equal to 5 wt %, less than or equal to 3 wt %, less than or equal to 1 wt %, or less than or equal to 0.5 wt % versus the total weight of the plurality of glass fibers in the fiber web or separator. Combinations of the above referenced ranges are also possible (e.g., greater than or equal to 1 wt % and less than or equal to 10 wt %, greater than or equal to 1 wt % and less than or equal to 7 wt %). Other ranges are also possible. In some embodiments, the plurality of glass fibers noted above may be the second plurality of glass fibers where more than one plurality of glass fibers (e.g., first plurality of fibers, second plurality of fibers) are present in a fiber web and/or separator. For instance, each recitation of “glass fibers” above may be replaced with “second plurality of glass fibers”. In some embodiments, individual glass fibers in the plurality of glass fibers have CaO present in the ranges described above with respect to the weight of the individual glass fibers. For example, the plurality of glass fibers may comprise individual fibers having greater than or equal to 0.2 wt % and less than or equal to 10 wt % CaO versus the weight of the individual fibers. In other embodiments, the plurality of glass fibers may comprise individual fibers having other combinations of ranges of CaO described above versus the weight of the individual fibers.

In some embodiments, the fiber web comprising a plurality of glass fibers (e.g., second plurality of fibers) and/or fused glass portions comprises CaO in an amount greater than or equal to 0.2 wt %, greater than or equal to 0.5 wt %, greater than or equal to 1 wt %, greater than or equal to 3 wt %, greater than or equal to 5 wt %, greater than or equal to 7 wt %, or greater than or equal to 9 wt % versus the total weight of the fiber web or separator. In certain embodiments, CaO is present in the fiber web in an amount less than or equal to 10 wt %, less than or equal to 9 wt %, less than or equal to 7 wt %, less than or equal to 5 wt %, or less than or equal to 3 wt %, less than or equal to 1 wt %, or less than or equal to 0.5 wt % versus the total weight of the fiber web or separator. Combinations of the above referenced ranges are also possible (e.g., greater than or equal to 1 wt % and less than or equal to 10 wt %, greater than or equal to 1 wt % and less than or equal to 7 wt %). Other ranges are also possible.

In certain embodiments, B₂O₃ is present in the plurality of glass fibers (and/or fused glass portions) in an amount greater than or equal to 0.2 wt %, greater than or equal to 0.5 wt %, greater than or equal to 1 wt %, greater than or equal to 2 wt %, greater than or equal to 4 wt %, greater than or equal to 4.5 wt %, greater than or equal to 5 wt %, greater than or equal to 6 wt %, greater than or equal to 6.5 wt %, or greater than or equal to 7 wt % versus the total weight of the plurality of glass fibers in the fiber web or separator. In certain embodiments, B₂O₃ is present in the plurality of glass fibers (and/or fused glass portions) in an amount less than or equal to 8 wt %, less than or equal to 7 wt %, less than or equal to 6.5 wt %, less than or equal to 6 wt %, less than or equal to 5 wt %, less than or equal to 4.5 wt %, less than or equal to 4 wt %, less than or equal to 2 wt %, less than or equal to 1 wt %, or less than or equal to 0.5 wt % versus the total weight of the plurality of glass fibers in the fiber web or separator. Combinations of the above referenced ranges are also possible (e.g., greater than or equal to 1 wt % and less than or equal to 8 wt %, greater than or equal to 4.5 wt % and less than or equal to 6.5 wt %). Other ranges are also possible. In some embodiments, the plurality of glass fibers noted above may be the second plurality of glass fibers where more than one plurality of glass fibers (e.g., first plurality of fibers, second plurality of fibers) are present in a fiber web and/or separator. For instance, each recitation of “glass fibers” above may be replaced with “second plurality of glass fibers”. In some embodiments, individual glass fibers in the plurality of glass fibers have B₂O₃ present in the ranges described above with respect to the weight of the individual glass fibers. For example, the plurality of glass fibers may comprise individual fibers having greater than or equal to 0.2 wt % and less than or equal to 8 wt % B₂O₃ versus the weight of the individual fibers. In other embodiments, the plurality of glass fibers may comprise individual fibers having other combinations of ranges of B₂O₃ described above versus the weight of the individual fibers.

In certain embodiments, the fiber web comprising a plurality of glass fibers (e.g., second plurality of fibers) and/or fused glass portions comprises B₂O₃ in an amount greater than or equal to 0.2 wt %, greater than or equal to 0.5 wt %, greater than or equal to 1 wt %, greater than or equal to 2 wt %, greater than or equal to 4 wt %, greater than or equal to 4.5 wt %, greater than or equal to 5 wt %, greater than or equal to 6 wt %, greater than or equal to 6.5 wt %, or greater than or equal to 7 wt % versus the total weight of the fiber web or separator. In certain embodiments, the fiber web comprises B₂O₃ in an amount less than or equal to 8 wt %, less than or equal to 7 wt %, less than or equal to 6.5 wt %, less than or equal to 6 wt %, less than or equal to 5 wt %, less than or equal to 4.5 wt %, less than or equal to 4 wt %, less than or equal to 2 wt %, less than or equal to 1 wt %, or less than or equal to 0.5 wt % versus the total weight of the fiber web or separator. Combinations of the above referenced ranges are also possible (e.g., greater than or equal to 1 wt % and less than or equal to 8 wt %, greater than or equal to 4.5 wt % and less than or equal to 6.5 wt %). Other ranges are also possible.

In some embodiments, K₂O is present in the plurality of glass fibers (and/or fused glass portions) in an amount greater than or equal to 0.1 wt %, greater than or equal to 0.2 wt %, greater than or equal to 0.5 wt %, greater than or equal to 1 wt %, greater than or equal to 1.5 wt %, greater than or equal to 1.9 wt %, greater than or equal to 2 wt %, greater than or equal to 2.5 wt %, greater than or equal to 3 wt %, or greater than or equal to 3.5 wt % versus the total weight of the plurality of glass fibers in the fiber web or separator. In certain embodiments, K₂O is present in the plurality of glass fibers (and/or fused glass portions) in an amount less than or equal to 4 wt %, less than or equal to 3.5 wt %, less than or equal to 3 wt %, less than or equal to 2 wt %, less than or equal to 2 wt %, less than or equal to 1.9 wt %, less than or equal to 1.5 wt %, less than or equal to 1 wt %, less than or equal to 0.5 wt %, or less than or equal to 0.2 wt % versus the total weight of the plurality of glass fibers in the fiber web or separator. Combinations of the above referenced ranges are also possible (e.g., greater than or equal to 0.1 wt % and less than or equal to 4 wt %, greater than or equal to 2 wt % and less than or equal to 3.5 wt %). Other ranges are also possible. In some embodiments, the plurality of glass fibers noted above may be the second plurality of glass fibers where more than one plurality of glass fibers (e.g., first plurality of fibers, second plurality of fibers) are present in a fiber web and/or separator. For instance, each recitation of “glass fibers” above may be replaced with “second plurality of glass fibers”. In some embodiments, individual glass fibers in the plurality of glass fibers have K₂O present in the ranges described above with respect to the weight of the individual glass fibers. For example, the plurality of glass fibers may comprise individual fibers having greater than or equal to 0.1 wt % and less than or equal to 4 wt % K₂O versus the weight of the individual fibers. In other embodiments, the plurality of glass fibers may comprise individual fibers having other combinations of ranges of K₂O described above versus the weight of the individual fibers.

In some embodiments, the fiber web comprising a plurality of glass fibers (e.g., second plurality of fibers) and/or fused glass portions comprises K₂O in an amount greater than or equal to 0.1 wt %, greater than or equal to 0.2 wt %, greater than or equal to 0.5 wt %, greater than or equal to 1 wt %, greater than or equal to 1.5 wt %, greater than or equal to 1.9 wt % greater than or equal to 2 wt %, greater than or equal to 2.5 wt %, greater than or equal to 3 wt %, or greater than or equal to 3.5 wt % versus the total weight of the fiber web or separator. In certain embodiments, K₂O is present in the fiber web in an amount less than or equal to 4 wt %, less than or equal to 3.5 wt %, less than or equal to 3 wt %, less than or equal to 2 wt %, less than or equal to 2 wt %, less than or equal to 1.9 wt %, less than or equal to 1.5 wt %, less than or equal to 1 wt %, less than or equal to 0.5 wt %, or less than or equal to 0.2 wt % versus the total weight of the fiber web or separator. Combinations of the above referenced ranges are also possible (e.g., greater than or equal to 0.1 wt % and less than or equal to 4 wt %, greater than or equal to 2 wt % and less than or equal to 3.5 wt %). Other ranges are also possible.

In some embodiments, F₂ is present in the plurality of glass fibers (and/or fused glass portions) in an amount greater than or equal to 0 wt %, greater than or equal to 0.2 wt %, greater than or equal to 0.4 wt %, greater than or equal to 0.8 wt %, greater than or equal to 1 wt %, or greater than or equal to 1.5 wt % versus the total weight of the plurality of glass fibers in the fiber web or separator. In certain embodiments, F₂ is present in the plurality of glass fibers (and/or fused glass portions) in an amount less than or equal to 2 wt %, less than or equal to 1.5 wt %, less than or equal to 1 wt %, less than or equal to 0.8 wt %, less than or equal to 0.4 wt %, or less than or equal to 0.2 wt % versus the total weight of the plurality of glass fibers in the fiber web or separator. Combinations of the above referenced ranges are also possible (e.g., greater than or equal to 0 wt % and less than or equal to 2 wt %, greater than or equal to 0.4 wt % and less than or equal to 1 wt %). Other ranges are also possible. In some embodiments, the plurality of glass fibers noted above may be the second plurality of glass fibers where more than one plurality of glass fibers (e.g., first plurality of fibers, second plurality of fibers) are present in a fiber web and/or separator. For instance, each recitation of “glass fibers” above may be replaced with “second plurality of glass fibers”. In some embodiments, individual glass fibers in the plurality of glass fibers have F₂ present in the ranges described above with respect to the weight of the individual glass fibers. For example, the plurality of glass fibers may comprise individual fibers having greater than or equal to 0 wt % and less than or equal to 2 wt % F₂ versus the weight of the individual fibers. In other embodiments, the plurality of glass fibers may comprise individual fibers having other combinations of ranges of F₂ described above versus the weight of the individual fibers.

In some embodiments, the fiber web comprising a plurality of glass fibers (e.g., second plurality of fibers) and/or fused glass portions comprises F₂ in an amount greater than or equal to 0 wt %, greater than or equal to 0.2 wt %, greater than or equal to 0.4 wt %, greater than or equal to 0.8 wt %, greater than or equal to 1 wt %, or greater than or equal to 1.5 wt % versus the total weight of the fiber web or separator. In certain embodiments, F₂ is present in the fiber web in an amount less than or equal to 2 wt %, less than or equal to 1.5 wt %, less than or equal to 1 wt %, less than or equal to 0.8 wt %, less than or equal to 0.4 wt %, or less than or equal to 0.2 wt % versus the total weight of the fiber web or separator. Combinations of the above referenced ranges are also possible (e.g., greater than or equal to 0 wt % and less than or equal to 2 wt %, greater than or equal to 0.4 wt % and less than or equal to 1 wt %). Other ranges are also possible.

In certain embodiments, Na₂O is present in the plurality of glass fibers (and/or fused glass portions) in an amount greater than or equal to 0.5 wt %, greater than or equal to 1 wt %, greater than or equal to 2 wt %, greater than or equal to 5 wt %, greater than or equal to 7 wt %, greater than or equal to 9 wt %, greater than or equal to 10 wt %, greater than or equal to 12 wt %, or greater than or equal to 16 wt % versus the total weight of the plurality of glass fibers in the fiber web or separator. In certain embodiments, Na₂O is present in the plurality of glass fibers (and/or fused glass portions) in an amount less than or equal to 20 wt %, less than or equal to 16 wt %, less than or equal to 12 wt %, less than or equal to 10 wt %, less than or equal to 9 wt %, less than or equal to 7 wt %, less than or equal to 5 wt %, less than or equal to 2 wt %, or less than or equal to 1 wt % versus the total weight of the plurality of glass fibers in the fiber web or separator. Combinations of the above referenced ranges are also possible (e.g., greater than or equal to 0.5 wt % and less than or equal to 20 wt %, greater than or equal to 7 wt % and less than or equal to 20 wt %, greater than or equal to 9 wt % and less than or equal to 16 wt %). Other ranges are also possible. In some embodiments, the plurality of glass fibers noted above may be the second plurality of glass fibers where more than one plurality of glass fibers (e.g., first plurality of fibers, second plurality of fibers) are present in a fiber web and/or separator. For instance, each recitation of “glass fibers” above may be replaced with “second plurality of glass fibers”. In some embodiments, individual glass fibers in the plurality of glass fibers have Na₂O present in the ranges described above with respect to the weight of the individual glass fibers with respect to the weight of the individual glass fibers. For example, the plurality of glass fibers may comprise individual fibers having greater than or equal to 0.5 wt % and less than or equal to 20 wt % Na₂O versus the weight of the individual fibers. In other embodiments, the plurality of glass fibers may comprise individual fibers having other combinations of ranges of Na₂O described above versus the weight of the individual fibers.

In certain embodiments, the fiber web comprising a plurality of glass fibers (e.g., second plurality of fibers) and/or fused glass portions comprises Na₂O in an amount greater than or equal to 0.5 wt %, greater than or equal to 1 wt %, greater than or equal to 2 wt %, greater than or equal to 5 wt %, greater than or equal to 7 wt %, greater than or equal to 9 wt %, greater than or equal to 10 wt %, greater than or equal to 12 wt %, or greater than or equal to 16 wt % versus the total weight of the fiber web or separator. In certain embodiments, Na₂O is present in the fiber web in an amount less than or equal to 20 wt %, less than or equal to 16 wt %, less than or equal to 12 wt %, less than or equal to 10 wt %, less than or equal to 9 wt %, less than or equal to 7 wt %, less than or equal to 5 wt %, less than or equal to 2 wt %, or less than or equal to 1 wt % versus the total weight of the fiber web or separator. Combinations of the above referenced ranges are also possible (e.g., greater than or equal to 0.5 wt % and less than or equal to 20 wt %, greater than or equal to 9 wt % and less than or equal to 16 wt %). Other ranges are also possible.

In certain embodiments, BaO is present in the plurality of glass fibers (and/or fused glass portions) in an amount less than or equal to 0.06 wt %, less than or equal to 0.05 wt %, less than or equal to 0.04 wt %, less than or equal to 0.03 wt %, less than or equal to 0.02 wt %, or less than or equal to 0.01 wt % versus the total weight of the plurality of glass fibers in the fiber web or separator. In some embodiments, BaO is present in the plurality of glass fibers (and/or fused glass fiber portions) in an amount greater than or equal to 0 wt %, greater than or equal to 0.01 wt %, greater than or equal to 0.02 wt %, greater than or equal to 0.03 wt %, greater than or equal to 0.04 wt %, or greater than or equal to 0.05 wt % versus the total weight of the plurality of glass fibers in the fiber web or separator. Combinations of the above referenced ranges are also possible (e.g., less than or equal to 0.06 wt % and greater than or equal to 0 wt %). Other ranges are also possible. In some embodiments, the plurality of glass fibers noted above may be the second plurality of glass fibers where more than one plurality of glass fibers (e.g., first plurality of fibers, second plurality of fibers) are present in a fiber web and/or separator. For instance, each recitation of “glass fibers” above may be replaced with “second plurality of glass fibers”. In some embodiments, individual glass fibers in the plurality of glass fibers have BaO present in the ranges described above with respect to the weight of the individual glass fibers.

In certain embodiments, the fiber web comprising a plurality of glass fibers (e.g., second plurality of fibers) and/or fused glass portions comprises BaO in an amount less than or equal to 0.06 wt %, less than or equal to 0.05 wt %, less than or equal to 0.04 wt %, less than or equal to 0.03 wt %, less than or equal to 0.02 wt %, or less than or equal to 0.01 wt % versus the total weight of the fiber web or separator. In certain embodiments, BaO is present in the fiber web in an amount greater than or equal to 0 wt %, greater than or equal to 0.01 wt %, greater than or equal to 0.02 wt %, greater than or equal to 0.03 wt %, greater than or equal to 0.04 wt %, or greater than or equal to 0.05 wt % versus the total weight of the fiber web or separator. Combinations of the above referenced ranges are also possible (e.g., less than or equal to 0.06 wt % and greater than or equal to 0 wt %). Other ranges are also possible.

In an exemplary embodiment, the plurality of glass fibers (e.g., the second plurality of glass fibers where more than one plurality of fibers are present) comprises greater than or equal to 2 wt % and less than or equal to 7 wt % Li₂O, greater than or equal to 50 wt % and less than or equal to 80 wt % SiO₂, greater than or equal to 1 wt % and less than or equal to 6 wt % Al₂O₃, greater than or equal to 1 wt % and less than or equal to 6 wt % MgO, greater than or equal to 1 wt % and less than or equal to 10 wt % CaO, greater than or equal to 1 wt % and less than or equal to 8 wt % B₂O₃, greater than or equal to 0.1 wt % and less than or equal to 5 wt % K₂O, greater than or equal to 0 wt % and less than or equal to 2 wt % F₂, and greater than or equal to 9 wt % and less than or equal to 16 wt % Na₂O versus the total weight of the plurality of glass fibers (e.g., the second plurality of glass fibers). Other compositions are also possible.

In some embodiments, the total amount of MgO, CaO, and BaO present in the second plurality of glass fibers (e.g., plurality of glass fibers having a relatively low softening temperature, such as a softening temperature of less than or equal to 550° C.) is less than or equal to 9 wt %, less than or equal to 8 wt %, less than or equal to 7 wt %, less than or equal to 6 wt %, less than or equal to 5 wt %, less than or equal to 4 wt %, less than or equal to 3 wt %, or less than or equal to 2.5 wt % versus the total weight of the second plurality of glass fibers in the fiber web or separator. In some embodiments, the total amount of MgO, CaO, and BaO present in the second plurality of glass fibers is greater than or equal to 2 wt %, greater than or equal to 2.5 wt %, greater than or equal to 3 wt %, greater than or equal to 4 wt %, greater than or equal to 5 wt %, greater than or equal to 6 wt %, greater than or equal to 7 wt %, or greater than or equal to 8 wt % versus the total weight of the second plurality of glass fibers in the fiber web or separator. Combinations of the above-referenced ranges are also possible (e.g., less than or equal to 9 wt % and greater than or equal to 2 wt %). Other ranges are also possible.

In certain embodiments, the first plurality of glass fibers (e.g., plurality of glass fibers having a relatively high softening temperature, such as a softening temperature of greater than 550° C.) may have a different chemical composition than the second plurality of glass fibers (e.g., plurality of glass fibers having a relatively low softening temperature, such as a softening temperature of less than or equal to 550° C.). For example, in some embodiments, the second plurality of glass fibers may comprise one or more of SiO₂, Al₂O₃, B₂O₃, Na₂O, K₂O, CaO, MgO, BaO, Fe₂O₃, TiO₂, F₂, and Li₂O in a different amount than the first plurality of glass fibers. In an exemplary embodiment, the second plurality of glass fibers comprises greater than or equal to 2 wt % and less than or equal to 7 wt % Li₂O and the first plurality of glass fibers comprises substantially no Li₂O. In another exemplary embodiment, the second plurality of glass fibers comprises substantially no TiO₂ and the first plurality of glass fibers comprises greater than or equal to 0.2 wt % and less than or equal to 0.5 wt % TiO₂.

In some embodiments, the chemical composition of the first plurality of glass fibers (e.g., a plurality of glass fibers having a relatively high softening temperature, such as a softening temperature of greater than 550° C.) and the second plurality of glass fibers (e.g., a plurality of glass fibers having a relatively low softening temperature, such as a softening temperature of less than or equal to 550° C.) are different. In some embodiments, the first plurality of glass fibers are a plurality of glass fibers of a first type and the second plurality of glass fibers are a plurality of glass fibers of a second type. The first type of glass fibers may differ from the second type of glass fibers by chemical composition. The glass fibers of the first type may, for example, have a relatively high softening temperature and the glass fibers of the second type may have a relatively low softening temperature. Without wishing to be bound by theory, the softening temperature of the glass fibers may be affected by the chemical composition of the fibers themselves. By way of an illustrative example, Table 1 shows the composition of exemplary microglass fibers having a relatively low softening temperature (e.g., a softening temperature of less than or equal to 550° C.), compared to microglass fibers having a relatively high softening temperature (e.g., a softening temperature of greater than 550° C.), and chopped strand fibers having a relatively high softening temperature (e.g., a softening temperature of greater than 550° C.).

TABLE 1

| | | Microglass fibers, | Microglass fibers, |
|---|---|---|---|
| | | relatively high | relatively low |
| | Chopped Strand | softening | softening |
| | Fibers | temperature | temperature |
| Oxide | (wt %) | (wt %) | (wt %) |
| SiO₂ | 59 | 68.5 | 64 |
| Al₂O₃ | 12.1-13.2 | 3.8 | 3.1 |
| B₂O₃ | 0 | 4.75 | 5.3 |
| Na₂O | 0.6-0.9 | 12 | 12 |
| K₂O | 0-0.2 | 1.8 | 2.9 |
| CaO | 22-23 | 5.7 | 5.9 |
| MgO | 3.1-3.4 | 2.8 | 3 |
| Fe₂O₃ | 0.2 | 0.05 | 0.05 |
| TiO₂ | 0.2-0.5 | 0 | 0 |
| F₂ | 0 | 0.6 | 0.8 |
| Li₂O | 0 | 0 | 3.0 |

In some embodiments, a fiber web described herein may include glass fibers (e.g., microglass fibers, chopped strand glass fibers, or a combination thereof). For instance, the first plurality of fibers and second plurality of fibers may each independently be microglass fibers or chopped strand glass fibers. Microglass fibers and chopped strand glass fibers are known to those of ordinary skill in the art. One of ordinary skill in the art is able to determine whether a glass fiber is microglass or chopped strand by observation (e.g., optical microscopy, electron microscopy). Microglass fibers may also have chemical differences from chopped strand glass fibers. In some cases, though not required, chopped strand glass fibers may contain a greater content of calcium or sodium than microglass fibers. For example, chopped strand glass fibers may be close to alkali free with high calcium oxide and alumina content. Microglass fibers may contain 10-15% alkali (e.g., sodium, magnesium oxides) and have relatively lower melting and processing temperatures. The terms refer to the technique(s) used to manufacture the glass fibers. Such techniques impart the glass fibers with certain characteristics. In general, chopped strand glass fibers are drawn from bushing tips and cut into fibers in a process similar to textile production. Chopped strand glass fibers are produced in a more controlled manner than microglass fibers, and as a result, chopped strand glass fibers will generally have less variation in fiber diameter and length than microglass fibers. Microglass fibers are drawn from bushing tips and further subjected to flame blowing or rotary spinning processes.

In some embodiments, the second plurality of fibers (e.g., plurality of glass fibers having a relatively low softening temperature, such as a softening temperature of less than or equal to 550° C.) comprise chopped strand fibers, microglass fibers, or combinations thereof.

The second plurality of glass fibers (e.g., fibers having a relatively low softening temperature, such as a softening temperature less than or equal to 550° C.) may have a particular average diameter. For instance, in some embodiments, the average diameter of the second plurality of glass fibers (e.g., fibers having a relatively low softening temperature) may be less than or equal to 13.5 microns, less than or equal to 10 microns, less than or equal to 9 microns, less than or equal to 7 microns, less than or equal to 5 microns, less than or equal to 3 microns, less than or equal to 1.7 microns, less than or equal to 1 micron, less than or equal to 0.7 microns, or less than or equal to 0.5 microns. In some instances, the second plurality of glass fibers may have an average fiber diameter of greater than or equal to 0.3 microns, greater than or equal to 0.4 microns, greater than or equal to 0.5 microns, greater than or equal to 0.7 microns, greater than or equal to 1 micron, greater than or equal to 1.7 microns, greater than or equal to 3 microns, greater than or equal to 5 microns, greater than or equal to 7 microns, greater than or equal to 9 microns, or greater than or equal to 10 microns. Combinations of the above-referenced ranges are also possible (e.g., greater than or equal to 0.4 microns and less than or equal to 13.5 microns, greater than or equal to 0.4 microns and less than or equal to 10 microns, greater than or equal to 0.7 microns and less than or equal to 1.7 microns). Other values of average fiber diameter are also possible. Average diameter distributions for the second plurality of glass fibers may be log-normal. However, it can be appreciated that the second plurality of glass fibers may be provided in any other appropriate average diameter distribution (e.g., Gaussian distribution).

In some embodiments, the average length of the second plurality of glass fibers (e.g., fibers having a relatively low softening temperature) may be less than or equal to 10 mm, less than or equal to 8 mm, less than or equal to 6 mm, less than or equal to 5 mm, less than or equal to 4 mm, less than or equal to 3 mm, less than or equal to 2 mm, less than or equal to 1 mm, less than or equal to 0.5 mm, less than or equal to 0.1 mm, or less than or equal to 0.05 mm. In certain embodiments, the average length of the second plurality of glass fibers may be greater than or equal to 0.01 mm, greater than or equal to 0.05 mm, greater than or equal to 0.1 mm, greater than or equal to 0.5 mm, greater than or equal to 1 mm, greater than or equal to 2 mm, greater than or equal to 4 mm, greater than or equal to 5 mm, greater than equal to 6 mm, or greater than or equal to 8 mm. Combinations of the above referenced ranges are also possible (e.g., a length of greater than or equal to 0.01 mm and less than or equal to 10 mm, greater than or equal to 0.1 mm and less or equal to than 1 mm). Other ranges are also possible.

As described herein, in some embodiments a fiber web or separator described herein includes a plurality of fused glass portions. The fused glass portions may be formed of fibers (e.g., second plurality of glass fibers) having an average diameter in one or more of the ranges indicated above for the second plurality of glass fibers. The fused glass portions may be formed from microglass fibers (e.g., softened microglass fibers) or chopped strand fibers (e.g., softened chopped strand fibers).

In some embodiments, the first plurality of glass fibers (e.g., fibers having a softening temperature greater than 550° C.) may comprise chopped strand fibers, microglass fibers, or combinations thereof.

In some cases, the first plurality of glass fibers (e.g., fibers having a relatively high softening temperature) may have an average fiber diameter that is different than the average diameter of the second plurality of glass fibers (e.g., fibers having a relatively low softening temperature). In certain embodiments, the first plurality of glass fibers (e.g., fibers having a relatively high softening temperature) may have an average fiber diameter of greater than or equal to 0.3 microns, greater than or equal to 0.5 microns, greater than or equal to 0.8 microns, greater than or equal to 1 micron, greater than or equal to 1.2 microns, greater than or equal to 1.5 microns, greater than or equal to 1.8 microns, greater than or equal to 2 microns, greater than or equal to 5 microns, greater than or equal to 7 microns, greater than or equal to 9 microns, greater than or equal to 11 microns, or greater than or equal to 20 microns. In some instances, the first plurality of glass fibers may have an average fiber diameter of less than or equal to 30 microns, less than or equal to 25 microns, less than or equal to 15 microns, less than or equal to 12 microns, less than or equal to 10 microns, less than or equal to 5 microns, less than or equal to 2 microns, less than or equal to 1.8 microns, less than or equal to 1.5 microns, less than or equal to 1.2 microns, less than or equal to 1 micron, less than or equal to 0.7 microns, or less than or equal to 0.5 microns. Combinations of the above-referenced ranges are also possible (e.g., greater than or equal to 0.8 microns and less than or equal to 30 microns, greater than or equal to 0.8 microns and less than or equal to 2.0 microns, greater than or equal to 5 microns and less than or equal to 12 microns). Other values of average fiber diameter are also possible. Average diameter distributions for the first plurality of glass fibers may be log-normal. However, it can be appreciated that the first plurality of glass fibers may be provided in any other appropriate average diameter distribution (e.g., Gaussian distribution).

In some embodiments, the average length of the first plurality of glass fibers (e.g., fibers having a relatively high softening temperature) may be less than or equal to 10 mm, less than or equal to 8 mm, less than or equal to 6 mm, less than or equal to 5 mm, less than or equal to 4 mm, less than or equal to 3 mm, less than or equal to 2 mm, less than or equal to 1 mm, less than or equal to 0.5 mm, less than or equal to 0.1 mm, or less than or equal to 0.05 mm. In certain embodiments, the average length of the first plurality of glass fibers (e.g., fibers having a relatively high softening temperature) may be greater than or equal to 0.01 mm, greater than or equal to 0.05 mm, greater than or equal to 0.1 mm, greater than or equal to 0.5 mm, greater than or equal to 1 mm, greater than or equal to 2 mm, greater than or equal to 4 mm, greater than or equal to 5 mm, greater than equal to 6 mm, or greater than or equal to 8 mm. Combinations of the above referenced ranges are also possible (e.g., an average length of greater than or equal to 0.01 mm and less than or equal to 10 mm, greater than or equal to 0.1 mm and less or equal to than 1 mm). Other ranges are also possible.

In some embodiments, the first plurality of fibers having an average fiber diameter in one or more of the above-referenced are microglass fibers. Non-limiting examples of microglass fibers are M-glass fibers according to Man Made Vitreous Fibers by Nomenclature Committee of TIMA Inc. March 1993, Page 45. In certain embodiments, the first plurality of fibers having an average fiber diameter in one or more of the above-referenced are chopped strand glass fibers. It should be appreciated that the above-noted dimensions are not limiting and that microglass and/or chopped strand fibers, as well as the other fibers described herein, may also have other dimensions.

A fiber web may include a suitable percentage of a second plurality of glass fibers (e.g., glass fibers having a relatively low softening temperature) within the fiber web or separator. In some embodiments, the weight percentage of the second plurality of glass fibers (e.g., fibers having a relatively low softening temperature, such as a softening temperature of less than or equal to 550° C.) may be greater than or equal to 1 wt %, greater than or equal to 2 wt %, greater than or equal to 5 wt %, greater than or equal to 15 wt %, greater than or equal to 25 wt %, or greater than or equal to 35 wt %, versus the total weight of the fiber web or separator. In certain embodiments, the weight percentage of second plurality of glass fibers may be less than or equal to 40 wt %, less than or equal to 35 wt %, less than or equal to 25 wt %, less than or equal to 15 wt %, less than or equal to 5 wt %, or less than or equal to 2 wt %, versus the total weight of the fiber web or separator. Combinations of the above-referenced ranges are also possible (e.g., greater than or equal to 1 wt % and less than or equal to 40 wt %, greater than or equal to 15 wt % and less than or equal to 35 wt %). Other ranges are also possible.

In certain embodiments, the weight percentage of the second plurality of glass fibers (e.g., glass fibers having a relatively low softening temperature) may be greater than or equal to 1 wt %, greater than or equal to 2 wt %, greater than or equal to 5 wt %, greater than or equal to 15 wt %, greater than or equal to 25 wt %, greater than or equal to 30 wt %, greater than or equal to 40 wt %, greater than or equal to 50 wt %, or greater than or equal to 60 wt %, versus the total weight of glass fibers in the fiber web or battery separator. In certain embodiments, the weight percentage of the second plurality of glass fibers in the fiber web may be less than or equal to 70 wt %, less than or equal to 60 wt %, less than or equal to 50 wt %, less than or equal to 40 wt %, less than or equal to 30 wt %, less than or equal to 25 wt %, less than or equal to 15 wt %, or less than or equal to 5 wt %, versus the total weight of glass fibers in the fiber web or battery separator. Combinations of the above-referenced ranges are also possible (e.g., greater than or equal to 1 wt % and less than or equal to 30 wt %, greater than or equal to 20 wt % and less than or equal to 70 wt %, greater than or equal to 40 wt % and less than or equal to 60 wt %). Other ranges are also possible.

In some embodiments, as described herein, the battery separator may comprise two or more fiber webs adjacent (e.g., directly adjacent) to one another (e.g., a first fiber web and a second fiber web). In some embodiments, at least one fiber web of the separator (e.g., a first fiber web, a second fiber web) comprises a second plurality of glass fibers (e.g., fibers having a relatively low softening temperature) in an amount of greater than or equal to 80 wt %, greater than or equal to 85 wt %, greater than or equal to 90 wt %, greater than or equal to 95 wt %, or greater than or equal to 98 wt %, versus the total weight of fibers in the fiber web (e.g., a first fiber web, a second fiber web). In certain embodiments, at least one fiber web of the separator (e.g., a first fiber web, a second fiber web) comprises a second plurality of glass in an amount of less than or equal to 100 wt %, less than or equal to 98 wt %, less than or equal to 95 wt %, less than or equal to 90 wt %, or less than or equal to 85 wt %, versus the total weight of fibers in the fiber web (e.g., a first fiber web, a second fiber web). Combinations of the above-referenced ranges are also possible (e.g., greater than or equal to 80 wt % and less than or equal to 100 wt %). Other ranges are also possible. In some embodiments, 100 wt % of the glass fibers in a fiber web of the battery separator are glass fibers having a relatively low softening temperature.

In some embodiments in which two or more fibers webs are present in a separator, the battery separator comprises a first plurality of glass fibers (e.g., fibers having a relatively high softening temperature) in an amount of greater than or equal to 10 wt %, greater than or equal to 15 wt %, greater than or equal to 25 wt %, greater than or equal to 30 wt %, greater than or equal to 40 wt %, greater than or equal to 50 wt %, greater than or equal to 55 wt %, greater than or equal to 60 wt %, greater than or equal to 65 wt %, or greater than or equal to 70 wt %, versus the total weight of battery separator. In certain embodiments, the weight percentage of first plurality of glass fibers may be less than or equal to 80 wt %, less than or equal to 70 wt %, less than or equal to 65 wt %, less than or equal to 60 wt %, less than or equal to 55 wt %, less than or equal to 50 wt %, less than or equal to 40 wt %, less than or equal to 30 wt %, less than or equal to 25 wt %, or less than or equal to 15 wt %, versus the total weight of the battery separator. Combinations of the above-referenced ranges are also possible (e.g., greater than or equal to 10 wt % and less than or equal to 80 wt %, greater than or equal to 50 wt % and less than or equal to 70 wt %, greater than or equal to 55 wt % and less than or equal to 65 wt %). Other ranges are also possible.

In some embodiments, the fiber web comprises a first plurality of glass fibers (e.g., fibers having a relatively high softening temperature), a second plurality of glass fibers (e.g., fibers having a relatively low softening temperature), and a third plurality of glass fibers (e.g., fibers having a relatively high softening temperature). In some such embodiments, the fiber web comprises at least a first plurality of glass fibers having a relatively high softening temperature (e.g., a first plurality of glass fibers and a third plurality of glass fibers) where the first plurality of glass fibers comprises microglass fibers and the third plurality of glass fibers comprises chopped strand fibers each having a relatively high softening temperature. In some such embodiments, the plurality of glass fibers having a relatively high softening temperature may comprise microglass fibers in an amount of greater than or equal to 80 wt %, greater than or equal to 85 wt %, or greater than or equal to 90 wt %, versus the total weight of fibers in the plurality of glass fibers having a relatively high softening temperature. In certain embodiments, the plurality of glass fibers having a relatively high softening temperature may comprise microglass fibers in an amount of less than or equal to 95 wt %, less than or equal to 90 wt %, or less than or equal to 85 wt %, versus the total weight of fibers in the plurality of glass fibers having a relatively high softening temperature. Combinations of the above-referenced ranges are also possible (e.g., greater than or equal to 80 wt % and less than or equal to 95 wt %). Other ranges are also possible.

In certain embodiments in which a mixture of microglass fibers and chopped strand fibers, each having a relatively high softening temperature, are present, the plurality(ies) of glass fibers having a relatively high softening temperature may comprise chopped strand fibers in an amount of greater than or equal to 5 wt %, greater than or equal to 10 wt %, or greater than or equal to 15 wt %, versus the total weight of fibers in the plurality of glass fibers having a relatively high softening temperature. In certain embodiments, the plurality(ies) of glass fibers having a relatively high softening temperature may comprise chopped strand fibers in an amount of less than or equal to 20 wt %, less than or equal to 15 wt %, or less than or equal to 10 wt %, versus the total weight of fibers in the plurality of glass fibers having a relatively high softening temperature. Combinations of the above-referenced ranges are also possible (e.g., greater than or equal to 5 wt % and less than or equal to 20 wt %). Other ranges are also possible.

In an exemplary embodiment, a fiber web (e.g., a fiber web of a battery separator) comprises a plurality of glass fibers, where at least a portion of the plurality of glass fibers are fused with one another and where the fiber web comprises a plurality of glass fibers having greater than or equal to 2 wt % and less than or equal to 7 wt % Li₂O.

In another exemplary embodiment, the fiber web comprises a first plurality of glass fibers and a second plurality of glass fibers. In some such embodiments, the first plurality of glass fibers has a first softening temperature and the second plurality of glass fibers has a second softening temperature. In some such embodiments, the first softening temperature may be greater than the second softening temperature by at least 40° C. In some cases, the second plurality of glass fibers may have a softening temperature of less than or equal to 550° C. In certain embodiments, the fiber web is formed by the process of heating the fiber web to a temperature of at least the second softening temperature but less than the first softening temperature. In some embodiments, the second plurality of glass fibers are present in the fiber web in an amount of at least 1 wt % versus the total fiber web weight. In certain embodiments, the first and second pluralities of glass fibers are microglass fibers. In some embodiments, the first plurality of glass fibers are microglass fibers having a first softening temperature and the second plurality of glass fibers are chopped strand fibers having a second softening temperature.

In yet another exemplary embodiment, the fiber web comprises a first plurality of glass fibers and a plurality of fused glass portions. In some embodiments, the first plurality of glass fibers has a first softening temperature, and the plurality of fused glass portions has a second softening temperature. In some such embodiments, the first softening temperature may be greater than the second softening temperature by at least 40° C. In some embodiments, the first plurality of glass fibers are microglass fibers, and the plurality of fused glass portions are formed from softened microglass fibers.

In some embodiments, the fiber webs described above and/or herein have a basis weight of greater than or equal to 10 gsm and less than or equal to 700 gsm.

In some embodiments, a fiber web and/or battery separator described herein may have desirable mechanical strength characteristics. For example, the fiber web and/or battery separator may be sufficiently strong to be used as a leaf and/or an envelope separator. In some embodiments, a fiber web (or one or more layers of the fiber web) and/or the overall battery separator may have a dry tensile strength in the machine direction of greater than or equal to 0.5 kg/cm², greater than or equal to 1 kg/cm², greater than or equal to 1.5 kg/cm², greater than or equal to 2 kg/cm², greater than or equal to 3 kg/cm², greater than or equal to 3.7 kg/cm², greater than or equal to 4 kg/cm², greater than or equal to 4.7 kg/cm², or greater than or equal to 5 kg/cm². In some instances, the dry tensile strength in the machine direction may be less than or equal to 6 kg/cm², less than or equal to 5 kg/cm², less than or equal to 4.7 kg/cm², less than or equal to 4 kg/cm², less than or equal to 3.7 kg/cm², less than or equal to 3 kg/cm², less than or equal to 2 kg/cm², less than or equal to 1.5 kg/cm², or less than or equal to 1 kg/cm². Combinations of the above-referenced ranges are also possible (e.g., greater than or equal to 0.5 kg/cm²and less than or equal to 6 kg/cm², greater than or equal to 3.7 kg/cm²and less than or equal to 4.7 kg/cm²). The dry tensile strength in the machine direction may be determined using the standard BCIS 03B Rev March 2010 Method 4.

In some embodiments, a fiber web (or one or more layers of the fiber web) and/or the overall battery separator may have a wet tensile strength in the machine direction of greater than or equal to 0.15 kg/cm², greater than or equal to 0.2 kg/cm², greater than or equal to 0.5 kg/cm², greater than or equal to 1 kg/cm², greater than or equal to 1.2 kg/cm², greater than or equal to 1.4 kg/cm², or greater than or equal to 1.5 kg/cm². In some instances, the wet tensile strength in the machine direction may be less than or equal to 1.7 kg/cm², less than or equal to 1.5 kg/cm², less than or equal to 1.4 kg/cm², less than or equal to 1.2 kg/cm², less than or equal to 1 kg/cm², less than or equal to 0.5 kg/cm², or less than or equal to 0.2 kg/cm². Combinations of the above-referenced ranges are also possible (e.g., greater than or equal to 0.15 kg/cm²and less than or equal to 1.7 kg/cm², greater than or equal to 1 kg/cm²and less than or equal to 1.4 kg/cm²). The wet tensile strength in the machine direction may be determined using the standard BCIS 03B Rev March 2010 Method 4.

In some embodiments, the puncture strength of a fiber web (or one or more layers of the fiber web) and/or a battery separator described herein may be greater than or equal to 1 N, greater than or equal to 1.5 N, greater than or equal to 2 N, greater than or equal to 3 N, greater than or equal to 4 N, greater than or equal to 5 N, greater than or equal to 6 N, or greater than or equal to 8 N. In some instances, the puncture strength may be less than or equal to 10 N, less than or equal to 8 N, less than or equal to 6 N, less than or equal to 5 N, less than or equal to 4 N, less than or equal to 3 N, less than or equal to 2 N, or less than or equal to 1.5 N. Combinations of the above-referenced ranges are also possible (e.g., greater than or equal to 1 N and less than or equal to 10 N, greater than or equal to 2 N and less than or equal to 4 N). The puncture strength may be determined using protocol BCIS 03B Rev March 2010 Method 9.

In some embodiments, the basis weight of a fiber web (or one or more layers of the fiber web) and/or the overall battery separator may range from between 10 g/m² and 700 g/m². For instance, in some embodiments, the basis weight of one or more layers of the battery separator (e.g., the non-woven web and/or the overall battery separator) may be greater than or equal to 10 g/m², greater than or equal to 25 g/m², greater than or equal to 40 g/m², greater than or equal to 60 g/m², greater than or equal to 80 g/m², greater than or equal to 100 g/m², greater than or equal to 150 g/m², greater than or equal to 200 g/m², greater than or equal to 250 g/m², greater than or equal to 300 g/m², greater than or equal to 350 g/m², greater than or equal to 400 g/m², greater than or equal to 500 g/m², or greater than or equal to 600 g/m². In some cases, the basis weight may be less than or equal to 700 g/m², less than or equal 600 g/m², less than or equal 500 g/m², less than or equal 400 g/m², less than or equal to 350 g/m², less than or equal to 300 g/m², less than or equal to 250 g/m², less than or equal to 200 g/m², less than or equal to 150 g/m², less than or equal to 100 g/m², less than or equal to 80 g/m², less than or equal to 60 g/m², less than or equal to 40 g/m², or less than or equal to 25 g/m². Combinations of the above-referenced ranges are also possible (e.g., greater than or equal to 10 g/m² and less than or equal to 700 g/m², greater than or equal to 200 g/m² and less than or equal to 350 g/m²). Other ranges are also possible. As determined herein, the basis weight of the fiber web and/or battery separator is measured according to the BCIS-03A, September-9, Method 5.

Thickness, as referred to herein, is determined according to BCIS 03-A September-9, Method 10 using 10 kPa pressure. The thickness of a fiber web (or one or more layers of the fiber web) and/or the overall battery separator may be between 0.1 mm and 5 mm. In some embodiments, the thickness of the non-woven web and/or battery separator may be greater than or equal to 0.1 mm, greater than or equal to 0.2 mm, greater than or equal to 0.3 mm, greater than or equal to 0.5 mm, greater than or equal to 0.8 mm, greater than or equal to 1 mm, greater than or equal to 1.3 mm, greater than or equal to 1.5 mm, greater than or equal to 1.8 mm, greater than or equal to 2 mm, greater than or equal to 2.3 mm, greater than or equal to 2.5 mm, greater than or equal to 2.8 mm, greater than or equal to 3 mm, or greater than or equal to 4 mm. In certain embodiments, the thickness may be less than or equal to 5 mm, less than or equal to 4 mm, less than or equal to 3 mm, less than or equal to 2.8 mm, less than or equal to 2.5 mm, less than or equal to 2.3 mm, less than or equal to 1.8 mm, less than or equal to 1.5 mm, less than or equal to 1.3 mm, less than or equal to 1 mm, less than or equal to 0.8 mm, less than or equal to 0.5 mm, less than or equal to 0.3 mm, or less than or equal to 0.2 mm. Combinations of the above-referenced ranges are also possible (e.g., greater than or equal to 0.1 mm and less than or equal to 5 mm, greater than or equal to 1.3 mm and less than or equal to 2.3 mm). Other ranges are also possible.

The fiber web (or one or more layers of the fiber web) and/or the overall battery separator may exhibit a suitable median pore size (e.g., for ionic conduction). In some embodiments, the median pore may be less than or equal to 40 microns, less than or equal to 30 microns, less than or equal to 25 microns, less than or equal to 20 microns, less than or equal to 15 microns, less than or equal to 10 microns, less than or equal to 7 microns, less than or equal to 5 microns, less than or equal to 3 microns, or less than or equal to 2 microns. In other embodiments, the median pore size may be greater than or equal to 1 micron, greater than or equal to 2 microns, greater than or equal to 5 microns, greater than or equal to 7 microns, greater than or equal to 10 microns, greater than or equal to 15 microns, greater than or equal to 20 microns, greater than or equal to 25 microns, greater than or equal to 30 microns, or greater than or equal to 35 microns. Combinations of the above-referenced ranges are also possible (e.g., greater than or equal to 1 microns and less than or equal to 40 microns, greater than or equal to 7 microns and less than or equal to 15 microns). Other values and ranges of median pore size are also possible. Median pore size, as determined herein, is measured according to the standard BCIS-03A, September-9, Method 6 using liquid porosimetry.

In certain embodiments, a fiber web (or one or more layers of the fiber web and/or the overall battery separator may have a specific surface area. In some embodiments, the specific surface area of the fiber web and/or battery separator is greater than or equal to 0.2 m²/g, greater than or equal to 0.5 m²/g, greater than or equal to 0.7 m²/g, greater than or equal to 0.9 m²/g, greater than or equal to 1.2 m²/g, greater than or equal to 1.5 m²/g, greater than or equal to 1.8 m²/g, greater than or equal to 2 m²/g, greater than or equal to 3 m²/g, or greater than or equal to 4 m²/g. In certain embodiments, the specific surface area of the fiber web and/or battery separator is less than or equal to 5 m²/g, less than or equal to 4 m²/g, less than or equal to 3 m²/g, less than or equal to 2 m²/g, less than or equal to 1.8 m²/g, less than or equal to 1.5 m²/g, less than or equal to 1.2 m²/g, less than or equal to 0.9 m²/g, less than or equal to 0.7 m²/g, or less than or equal to 0.5 m²/g. Combinations of the above-referenced ranges are also possible (e.g., greater than or equal to 0.2 m²/g and less than or equal to 5 m²/g, greater than or equal to 0.9 m²/g and less than or equal to 1.8 m²/g). Other ranges are also possible. Specific surface area, as determined herein, is measured according to the standard BCIS-03A, September-9, Method 8.

In some embodiments, a separator described herein may be used in a battery (e.g., lead acid battery). The battery may comprise a negative plate, a positive plate, and a battery separator (e.g., including a non-woven web described herein) disposed between the negative and positive plates.

It is to be understood that the other components of the battery that are not explicitly discussed herein can be conventional battery components. Positive plates and negative plates can be formed of conventional lead acid battery plate materials. For example, in container formatted batteries, plates can include grids that include a conductive material, which can include, but is not limited to, lead, lead alloys, graphite, carbon, carbon foam, titanium, ceramics (such as Ebonex®), laminates and composite materials. The grids are typically pasted with active materials. The pasted grids are typically converted to positive and negative battery plates by a process called “formation.” Formation involves passing an electric current through an assembly of alternating positive and negative plates with separators between adjacent plates while the assembly is in a suitable electrolyte (e.g., to convert pasted oxide to active materials).

As a specific example, positive plates may contain lead dioxide as the active material, and negative plates may contain lead as the active material. Plates can also contain one or more reinforcing materials, such as chopped organic fibers (e.g., having an average length of 0.125 inch or more), chopped glass fibers, metal sulfate(s) (e.g., nickel sulfate, copper sulfate), red lead (e.g., a Pb₃O₄-containing material), litharge, paraffin oil, and/or expander(s). In some embodiments, an expander contains barium sulfate, carbon black and lignin sulfonate as the primary components. The components of the expander(s) can be pre-mixed or not pre-mixed. Expanders are commercially available from, for example, Hammond Lead Products (Hammond, Ind.) and Atomized Products Group, Inc. (Garland, Tex.).

An example of a commercially available expander is the Texex® expander (Atomized Products Group, Inc.). In certain embodiments, the expander(s), metal sulfate(s) and/or paraffin are present in positive plates, but not negative plates. In some embodiments, positive plates and/or negative plates contain fibrous material or other glass compositions.

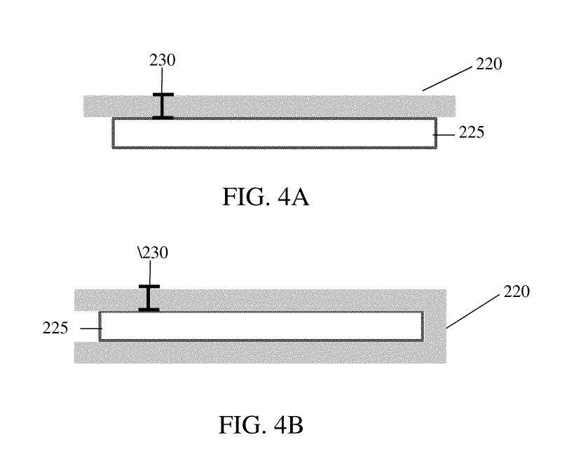

A battery can be assembled using any desired technique. For example, separators may be wrapped around plates (e.g., positive electrode, negative electrode). The positive plates, negative plates and separators are then assembled in a case using conventional lead acid battery assembly methods. The battery separators may be used, for example, as a leaf separator, as shown illustratively in FIG. 4A, or an envelope separator (i.e., the separator is sealed on three sides) as shown illustratively in FIG. 4B. FIG. 4A is a schematic diagram showing a cross-section of a battery separator 220 and a plate 225. The thickness 230 of each separator are also shown in FIGS. 4A-4B. In certain embodiments, separators are compressed after they are assembled in the case, i.e., the thickness of the separators are reduced after they are placed into the case. An electrolyte (e.g., sulfuric acid) is then disposed in the case.

The electrolyte can include other compositions. For example, the electrolyte can include liquids other than sulfuric acid, such as a hydroxide (e.g., potassium hydroxide). In some embodiments, the electrolyte includes one or more additives, including but not limited to a mixture of an iron chelate and a magnesium salt or chelate, organic polymers and lignin and/or organic molecules, and phosphoric acid. In some embodiments, the electrolyte is sulfuric acid. In some embodiments, the specific gravity of the sulfuric acid is between 1.21 g/cm³ and 1.40 g/cm³, or between 1.28 g/cm³ and 1.31 g/cm³. In certain embodiments the specific gravity of the sulfuric acid is 1.26 g/cm³. In certain embodiments the specific gravity of the sulfuric acid is about 1.3 g/cm³.

In some embodiments, the battery separators (including the fiber webs comprising a plurality of glass fibers where at least a portion of the glass fibers are fused to one another, as described herein) may be used in lead acid batteries including valve-regulated batteries (e.g., absorbent glass mat batteries) and flooded batteries. For example, in some embodiments, the battery separators may be used in flooded battery applications. In some such embodiments, the battery separator may be a enveloped separator that is wrapped around one or more plate (e.g., positive plate(s), positive and negative plate(s)).

As described herein, a fiber web may form all or part of a battery separator. In some embodiments, one or more additional layers or components are included with the fiber web (e.g., disposed adjacent to the fiber web, contacting one or both sides of the fiber web). In some instances, an additional layer is a fibrous layer. Non-limiting examples of fibrous additional layers include a meltblown layer, a wet laid layer (e.g., a glass fiber wet laid layer), a spunbond layer, an extruded layer, or an electrospun layer. In some embodiments, multiple non-woven webs in accordance with embodiments may be layered together in forming a multi-layer sheet for use in a battery separator. In other embodiments, an additional layer may be a non-fibrous layer. For example, the layer may be a polymeric layer formed by an extrusion process (e.g., a membrane such as a PE membrane). Other configurations are also possible.

In some embodiments two or more fiber webs of a battery separator may be formed separately, and combined by any suitable method such as lamination, collation, or by use of adhesives. The two or more fiber webs of a battery separator may be formed using different processes, or the same process. For example, each of the fiber webs may be independently formed by a wet laid process, a non-wet laid process, or any other suitable process.

In some embodiments, two or more fiber webs may be formed by the same process. In some instances, the two or more fiber webs may be formed simultaneously.

Different layers may be adhered together by any suitable method. For instance, layers may be adhered by an adhesive and/or melt-bonded to one another on either side. Lamination and calendaring processes may also be used. In some embodiments, an additional layer may be formed from any type of fiber or blend of fibers via an added headbox or a coater and appropriately adhered to another layer.

A battery separator may include any suitable number of layers, e.g., at least 2, at least 3, at least 4, at least 5, at least 6, at least 7 layers. In some embodiments, a battery separator may include up to 10 layers.

Fiber webs described herein may be produced using suitable processes, such as a wet laid process. In general, a wet laid process involves mixing together fibers of one or more type; for example, glass fibers of one type (e.g., having a relatively high softening temperature) may be mixed together with glass fibers of another type (e.g., having a relatively low softening temperature), to provide a fiber slurry. The slurry may be, for example, an aqueous-based slurry. In certain embodiments, fibers, are optionally stored separately, or in combination, in various holding tanks prior to being mixed together.

For instance, a first fiber may be mixed and pulped together in one container and a second fiber may be mixed and pulped in a separate container. The first fibers and the second fibers may subsequently be combined together into a single fibrous mixture. Appropriate fibers may be processed through a pulper before and/or after being mixed together. In some embodiments, combinations of fibers are processed through a pulper and/or a holding tank prior to being mixed together. It can be appreciated that other components (e.g., inorganic particles) may also be introduced into the mixture. Furthermore, it should be appreciated that other combinations of fibers types may be used in fiber mixtures, such as the fiber types described herein.

In certain embodiments, a fiber web may be formed by a wet laid process. For example, in certain embodiments, a single dispersion (e.g., a pulp) in a solvent (e.g., an aqueous solvent such as water) or slurry can be applied onto a wire conveyor in a papermaking machine (e.g., a fourdrinier or, a round former, or a rotoformer) to form a single layer supported by the wire conveyor. Vacuum may be continuously applied to the dispersion of fibers during the above process to remove the solvent from the fibers, thereby resulting in an article containing the single layer.

In some embodiments, two or more fiber webs are formed by a wet laid process. For example, a first dispersion (e.g., a pulp) containing fibers in a solvent (e.g., an aqueous solvent such as water) can be applied onto a wire conveyor in a papermaking machine (e.g., a fourdrinier or, a round former, or a rotoformer) to form first layer supported by the wire conveyor. A second dispersion (e.g., another pulp) containing fibers in a solvent (e.g., an aqueous solvent such as water) is applied onto the first layer either at the same time or subsequent to deposition of the first layer on the wire. Vacuum is continuously applied to the first and second dispersions of fibers during the above process to remove the solvent from the fibers, thereby resulting in an article containing first and second layers. The article thus formed is then dried and, if necessary, further processed by using known methods to form multi-layered non-woven webs.

Any suitable method for creating a fiber slurry may be used. In some embodiments, further additives are added to the slurry to facilitate processing. The temperature may also be adjusted to a suitable range, for example, between 33° F. and 100° F. (e.g., between 50° F. and 85° F.). In some cases, the temperature of the slurry is maintained. In some instances, the temperature is not actively adjusted.

In some embodiments, the wet laid process uses similar equipment as in a conventional papermaking process, for example, a hydropulper, a former or a headbox, a dryer, and an optional converter. A non-woven web can also be made with a laboratory handsheet mold in some instances. As discussed above, the slurry may be prepared in one or more pulpers. After appropriately mixing the slurry in a pulper, the slurry may be pumped into a headbox where the slurry may or may not be combined with other slurries. Other additives may or may not be added. The slurry may also be diluted with additional water such that the final concentration of fiber is in a suitable range, such as for example, between about 0.1% and 0.5% by weight.

In some cases, the pH of the fiber slurry may be adjusted as desired. For instance, fibers of the slurry may be dispersed under acidic or neutral conditions.

Before the slurry is sent to a headbox, the slurry may optionally be passed through centrifugal cleaners and/or pressure screens for removing unfiberized material. The slurry may or may not be passed through additional equipment such as refiners or deflakers to further enhance the dispersion of the fibers. For example, deflakers may be useful to smooth out or remove lumps or protrusions that may arise at any point during formation of the fiber slurry. Fibers may then be collected on to a screen or wire at an appropriate rate using any suitable equipment, e.g., a fourdrinier, a rotoformer, a cylinder/round former, or an inclined wire fourdrinier.

### EXAMPLES

The following examples are intended to illustrate certain embodiments of the present invention, but are not to be construed as limiting and do not exemplify the full scope of the invention.

### Example 1

The following example involves a battery separator including a fiber web including a mixture of a first plurality of glass fibers and a second plurality of glass fibers. This example demonstrates that softening of the second plurality of glass fibers by heating the fibers to a softening temperature greater than the softening temperature of the second plurality of glass fibers causes at least a portion of the second plurality of glass fibers to fuse to one another.

A fiber web for a battery separator was formed, comprising a mixture of:

59 wt % microglass fibers having an average fiber diameter of about 1.2 microns and a softening temperature of about 582° C. (e.g., a first plurality of glass fibers);

30 wt % microglass fibers having an average fiber diameter of about 0.8 microns and a softening temperature of less than or equal to 550° C. (e.g., a second plurality of glass fibers); and

11 wt % chopped strand fibers having an average fiber diameter of about 13.5 microns and a softening temperature of about 700° C. (e.g., a third plurality of glass fibers).

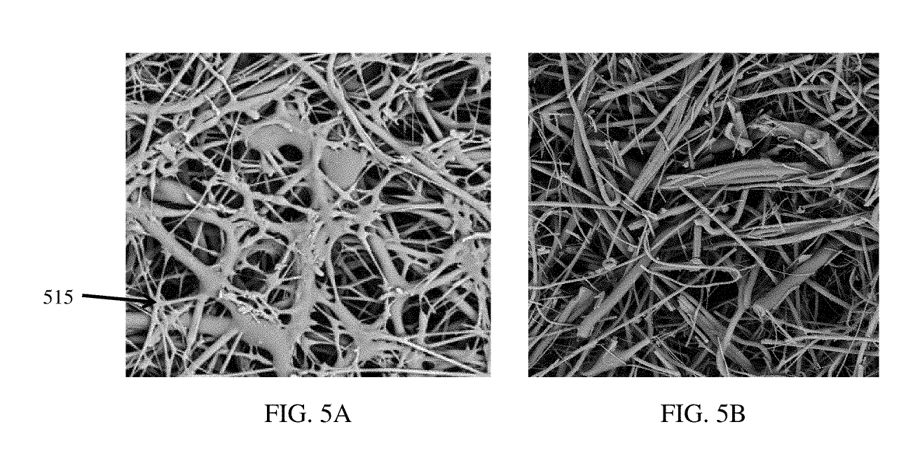

The fiber web was heated to 620° C. for 3 minutes. FIG. 5A shows an SEM image of the fiber web in Example 1 after heating, showing at least a portion of the glass fibers having a relatively low softening temperature of less than or equal to 550° C. have fused together (e.g., such as at fused region 515 in FIG. 5A).

### Comparative Example 1

A fiber web for a battery separator was manufactured, comprising a mixture of:

30 wt % microglass fibers having an average fiber diameter of about 0.8 microns and a softening temperature of about 582° C.;

59 wt % microglass fibers having an average fiber diameter of about 1.2 microns and a softening temperature of about 582° C.; and

11 wt % chopped strand fibers having an average fiber diameter of about 13.5 microns and a softening temperature of about 700° C.

The fiber web was heated to 620° C. for 3 minutes. FIG. 5B shows an SEM image of the fiber web after heating. The fibers were not fused to one another, as shown in FIG. 5B.

The basis weight of the fiber web was 250 g/m². The thickness of the fiber web was 1.9 mm (measured at 20 kPa).

### Example 2

A battery separator was manufactured, comprising:

a first fiber web as described in comparative example 1 (including a first plurality of glass fibers); and

a second fiber web adjacent the first fiber web, including 100 wt % microglass fibers having an average fiber diameter of about 0.8 microns and a softening temperature of less than or equal to 550° C. (e.g., a second plurality of glass fibers).

The second fiber web was deposited directly onto a surface of the first fiber web. The basis weight of the second fiber web was 80 g/m².

The thickness of the second fiber web was 0.6 mm (measured at 20 kPa).

The battery separator was heated such that at least a portion of the fibers of the second fiber web fused to one another and/or fused to at least a portion of the fibers of the first fiber web.

### Example 3

The following example demonstrates the dry tensile strength of the battery separators incorporating fiber webs as described herein.

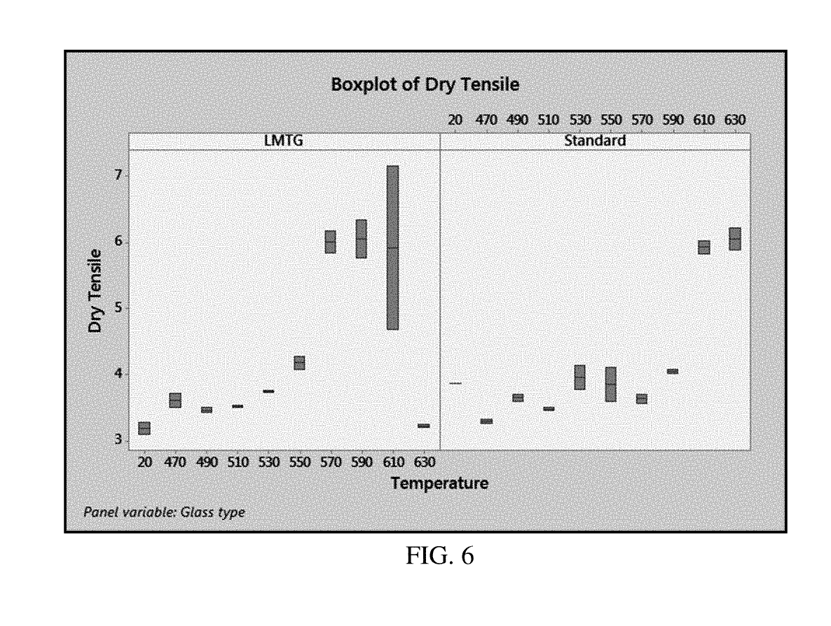

Battery separators were prepared as described in Comparative Example 1 and Example 1. FIG. 6 shows the dry tensile strength of the battery separator in Example 1 (LMTG) versus the dry tensile strength of the battery separator in Comparative Example 1 (Standard). The plots show that the dry tensile strength of the battery separator in Example 1 heated to 570° C. (a temperature at which at least a portion of the fibers in the battery separator have fused) is greater than the dry tensile strength of the battery separator of Comparative Example 1 heated to 570° C. (a temperature at which none of the fibers in the comparative battery separator have not fused). For example, the dry tensile strength of the battery separator in Example 1 heated to 570° C. is about 6 kg/cm² whereas the dry tensile strength of the battery separator in Comparative Example 1 heated to 570° C. is about 3.5 kg/cm².

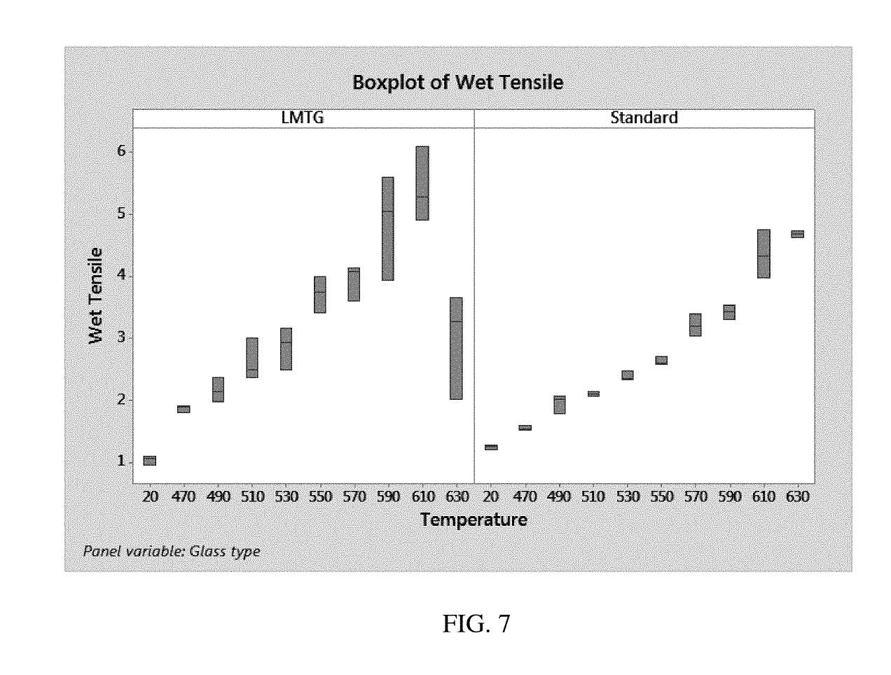

Similarly, FIG. 7 shows the wet tensile strength of the battery separator in Example 1 (LMTG) versus the wet tensile strength of the battery separator in Comparative Example 1 (Standard). The plots show that the wet tensile strength of the battery separator in Example 1 (LMTG) heated to 570° C. (a temperature at which at least a portion of the fibers in the battery separator have fused) is greater than the wet tensile strength of the battery separator in Comparative Example 1 (Standard) heated to 570° C. (a temperature at which at least a portion of the fibers in the battery separator have not fused). For example, the wet tensile strength of the battery separator in Example 1 heated to 570° C. is about 4 kg/cm² whereas the wet tensile strength of the battery separator in Comparative Example 1 heated to 570° C. is about 3 kg/cm².

1. A battery separator, comprising:
a fiber web comprising a plurality of glass fibers, wherein at least a portion of the plurality of glass fibers are fused with one another,
wherein the fiber web has a basis weight of greater than or equal to 10 gsm and less than or equal to 700 gsm,
wherein the plurality of glass fibers comprises individual fibers having greater than or equal to 2 wt % and less than or equal to 7 wt % Li₂O versus the weight of the individual fibers.

2. A battery separator, comprising:
a fiber web comprising a first plurality of glass fibers and a second plurality of glass fibers, wherein the first and second pluralities of glass fibers are microglass fibers,
wherein the fiber web has a basis weight of greater than or equal to 10 gsm and less than or equal to 700 gsm,
wherein the first plurality of glass fibers has a first softening temperature,
wherein the second plurality of glass fibers has a second softening temperature, and
wherein the first softening temperature is greater than the second softening temperature by at least 40° C.

3. A battery separator, comprising:
a fiber web comprising a first plurality of glass fibers and a plurality of fused glass portions, wherein the first plurality of glass fibers are microglass fibers, and wherein the plurality of fused glass portions are formed from softened microglass fibers;
wherein the fiber web has a basis weight of greater than or equal to 10 gsm and less than or equal to 700 gsm,
wherein the first plurality of glass fibers has a first softening temperature, and
wherein the plurality of fused glass portions has a second softening temperature,
wherein the first softening temperature is greater than the second softening temperature by at least 40° C.

4-6. (canceled)

7. An electrochemical cell, comprising:
an electrode; and
the battery separator of claim 1, adjacent the electrode.

8. An electrochemical cell as in claim 7, wherein the electrochemical cell is a lead-acid electrochemical cell.

9. A battery separator as in claim 2, wherein the plurality of glass fibers comprises individual fibers having greater than or equal to 2 wt % and less than or equal to 7 wt % Li₂O versus the weight of the individual fibers.

10. (canceled)

11. A battery separator as in claim 1, wherein the fiber web comprises a first layer comprising the plurality of glass fibers, wherein the plurality of glass fibers of the first layer are a first plurality of glass fibers, the fiber web comprising a second layer adjacent the first layer, the second layer comprising a second plurality of glass fibers.

12. A battery separator as in claim 11, further comprising a third layer disposed between the first layer and the second layer.

13. A battery separator as in claim 11, wherein the fiber web comprises a mixture of the first plurality of glass fibers and the second plurality of glass fibers.

14. A battery separator as in claim 11, wherein the first plurality of glass fibers are microglass fibers.

15. A battery separator as in claim 11, wherein the first plurality of glass fibers are chopped strand fibers.

16. A battery separator as in claim 11, wherein the second plurality of glass fibers are chopped strand fibers.

17. A battery separator as in claim 11, wherein the second plurality of glass fibers are microglass fibers.

18. A battery separator as in claim 11, wherein the second plurality of fibers having the second softening temperature are present in the fiber web in an amount of greater than or equal to 1 wt % and less than or equal to 30 wt %.

19. A battery separator as in claim 1, wherein the battery separator includes less than or equal to 5 wt % synthetic fibers.

20. A battery separator as in claim 11, wherein at least a portion of the second plurality of glass fibers have been subjected to softening to form a fused glass portion.

21. A battery separator as in claim 11, wherein at least a portion of the second plurality of glass fibers are fused to at least a portion of the first plurality of glass fibers.

22. A method for forming a battery separator, comprising:
heating a fiber web comprising a first plurality of glass fibers and a second plurality of glass fibers, wherein the first plurality of glass fibers and the second plurality of glass fibers are different in chemical composition; and
softening at least a portion of the second plurality of glass fibers.

23-31. (canceled)

32. A method as in claim 22, wherein the fiber web comprises a first layer comprising the first plurality of glass fibers and a second layer comprising the second plurality of glass fibers, wherein the first layer is directly adjacent the second layer.

33-39. (canceled)
